(19) United States
(12) Patent Application Publication
(10) Pub. No.: US 2012/0260158 A1
(43) Pub. Date: Oct. 11, 2012

(54) Enhanced World Wide Web-Based Communications

(76) Inventor: Ryan Steelberg, Irvine, CA (US)

(21) Appl. No.: 13/185,778

(22) Filed: Jul. 19, 2011

Related U.S. Application Data
(63) Continuation-in-part of application No. 13/045,131, filed on Mar. 10, 2011.
Application No. 13/045,131 is a continuation-in-part of application No. 12/856,032, filed on Aug. 13, 2010.
(60) Provisional application No. 61/471,966, filed on Apr. 5, 2011.
(60) Provisional application No. 61/382,588, filed on Sep. 14, 2010.

(51) Int. Cl. G06F 17/00

(52) U.S. Cl. 715/234

(57) ABSTRACT

A system for providing a browsing widget, comprising a javascript component that obtains primary content of a web page, at least one permission regarding the primary content; and a browsing widget for receiving browsing content produced remotely from said javascript component and forwarded over at least one network to said javascript component, wherein receipt of said browsing content by said javascript component modifies the primary content in accordance with the at least one permission.

### CROSS REFERENCE TO RELATED APPLICATIONS

This application is a continuation-in-part of U.S. Ser. No. 13/045,131 filed Mar. 10, 2011 entitled Apparatus, System and Method for a Media Enhancement Widget; U.S. Ser. No. 61/471,966 filed Apr. 5, 2011 entitled Apparatus, System and Method for a Media Enhancement Widget; U.S. Ser. No. 12/856,032 filed Aug. 13, 2010 entitled Apparatus, System and Method for a Media Enhancement Widget; and U.S. Ser. No. 61/382,588 filed Sep. 14, 2010 entitled Apparatus, System and Method for a Media Enhancement Widget; the entire disclosures of which are incorporated herein as if set forth in their entirety.

### BACKGROUND OF THE INVENTION

Use of the Internet has matured to the point where information and data processing resources accessible via the Internet are regularly relied on by users to enhance many aspects of their lives. The large majority of the Internet communications that most users are familiar with take place over the world wide web. Typically users access the web using a web browser that runs on a computing terminal of some type, such as a personal computer, web enabled tablet, smart phone, or the like. The web browser is used to access web servers that host web pages, typically containing hyperlinks to jump from one web page to another, and/or controls to invoke applications that run on servers. A user will “surf” the web by entering website names into the browser or following hyperlinks to locate web pages comprising text and/or audio/visual media of interest to the user. The web browser is also used to access web enabled applications, typically through the use of visual controls such as buttons, check boxes, drop down lists, and the like placed on web pages to trigger some sort of processing by the application. For example, shopping for goods and services via the web is commonplace. A web-based virtual storefront typically provides a search function to search for desired items which are generally displayed as images with information about the items, a virtual shopping basket to store selected items for purchase, and a checkout procedure that completes the purchase of the selected items and initiates shipping of the purchased items to a designated location.

The internet has also long been used as a platform for communications such as emails, text messaging, voice over IP (VoIP) calls, video conferencing, and the like. In addition, web-based social networking sites allow users to communicate within social groups, post their opinions and creative works, etc. Mechanisms also exist for users to communicate in real time over the web, such as with instant text messaging, audio and/or video conversations between two or more parties, or broadcasting text and/or audio/visual messages, programming, and the like from a broadcaster to a plurality of listeners/viewers. In short, the Internet, and more particularly the web, have permeated many aspects of users lives.

However, although there are many applications and functions available to users, they generally operate independently from one another. Most applications are not designed to cooperate with other applications. Moreover, switching from one application to another can be inconvenient. Consequently, using a second application in a way that relates to the subject matter of a first application is generally clumsy, requiring several steps including mouse clicks, keystrokes, and typing words, names, or phrases, and the like, depending on the context.

In view of the foregoing, it is desirable to have a framework that provides for the cooperation of otherwise unrelated applications, eases switching from one application to another, and generally mitigates the shortcomings of the prior art. It is also desirable to provide a framework that facilitates transactions, user-to-user communications, and the creation of new relationships and new ways for users to interact.

### SUMMARY

Systems and methods are described that provide a framework for coordinating the operation and interaction of otherwise unrelated applications and eases switching from one application to another, and facilitates transactions, user-to-user communications, and the creation of new relationships and new ways for users to interact.

Thus, the present invention provides a framework that provides for the cooperation of otherwise unrelated applications, eases switching from one application to another, and generally mitigates the shortcomings of the prior art, asd well as a framework that facilitates transactions, user-to-user communications, and the creation of new relationships and new ways for users to interact

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is an illustration of aspects of the present invention;

FIG. 2 is an illustration of aspects of the present invention;

FIG. 3 are an illustration of aspects of the present invention;

FIG. 4 are an illustration of aspects of the present invention;

FIG. 5 are an illustration of aspects of the present invention;

FIG. 6 are an illustration of aspects of the present invention;

FIG. 7 are an illustration of aspects of the present invention;

FIG. 8 are an illustration of aspects of the present invention;

FIG. 9 is an illustration of aspects of the present invention;

FIG. 10 is an illustration of aspects of the present invention;

FIG. 11 is an illustration of aspects of the present invention;

FIG. 12 is an illustration of aspects of the present invention;

FIG. 13 is an illustration of aspects of the present invention;

FIG. 14 is an illustration of aspects of the present invention;

FIG. 15 is an illustration of aspects of the present invention;

FIG. 16 is an illustration of aspects of the present invention;

FIG. 17 is an illustration of aspects of the present invention;

FIG. 18 is an illustration of aspects of the present invention;

FIG. 19 is an illustration of aspects of the present invention;

FIG. 20 is an illustration of aspects of the present invention;

FIG. 21 is an illustration of aspects of the present invention; and

FIG. 22 is an illustration of aspects of the present invention.

### DETAILED DESCRIPTION

It is to be understood that the figures and descriptions of the present invention have been simplified to illustrate elements that are relevant for a clear understanding of the present invention, while eliminating, for the purposes of clarity, many other elements found in typical computing apparatuses, systems and methods. Those of ordinary skill in the art will recognize that other elements are desirable and/or required in order to implement the present invention. However, because such elements are well known in the art, and because they do not facilitate a better understanding of the present invention, a discussion of such elements is not provided herein.

Reference will now be made in detail to various embodiments of the present invention, examples of which are illustrated in the accompanying drawings.

Illustrative Computing Environment

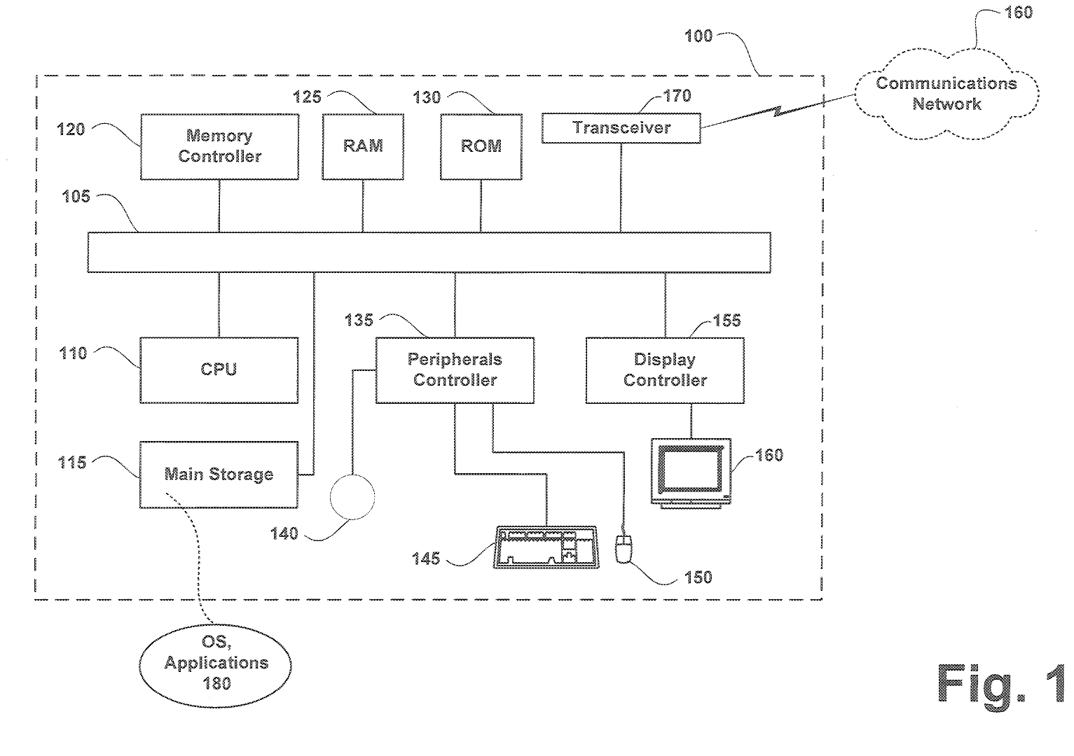

FIG. 1 depicts an exemplary computing terminal 100 for use in accordance with herein described system and methods. For the purposes of illustration, a conventional personal computer (PC) is shown, although other types of computing terminals, such as smart phones, computing tablets, and the like may also be used. The computing terminal 100 is capable of executing an operating system and computing application 180. Computing application 180 is a web browser that may comprise one or more addons such as snapins, plugins, extensions, themes, scripts, applets, and the like. Application 180 comprises sets of instructions (software), which are executed by processor 110 to perform one or more operations, functions, and/or procedures. Processor 110 is generally an integrated circuit microprocessor, referred to as a central processing unit (CPU).

In operation, CPU 110 fetches and executes instructions, such as from main storage device 115 which may be a hard disk drive (HDD), solid state drive, optical drive, or the like, and transfers data to and from other resources via the computer's main data-transfer path, system bus 105. Such a system bus connects various components of the computing terminal 100 and defines the internal medium for data exchange. Other data storage devices coupled to the system bus 105 may include high-speed random access memory (RAM) 125 and read only memory (ROM) 130. Such memories include elements that allow information to be stored and retrieved. ROM 130 generally stores data such that it can only be read but not modified, whereas RAM 125 stores data that may be read, modified, and/or added to by CPU 110 or other hardware devices. Access to the RAM 125 and/or ROM 130 may be controlled by memory controller 120. The memory controller 120 may provide an address translation function that translates virtual addresses into physical addresses as instructions are executed.

In addition, computing terminal 100 may comprise peripheral controller 135, such as a Peripheral Component Interconnect (PCI) or Universal Serial Bus (USB) controller, responsible for communicating instructions and other data between system bus 105 and internal and/or external devices such as speaker 140, keyboard 145, and mouse 150, although other peripheral devices (not shown) may also be used. Display 160, which is controlled by a display controller 155, is used to display visual output of the computing terminal 100. Such visual output may include text, graphics, animated graphics, and video. The display controller 155 includes elements that generate a video signal that is sent to display 160 for display, often coordinated with a corresponding sound signal that is sent to speaker 140. Further, the computing terminal 100 can comprise a network adaptor, modem, and/or other transceiver 170, which may be wired or wireless, to connect the computing terminal 100 to an external communication network 160.

Illustrative Networked Computing Environment:

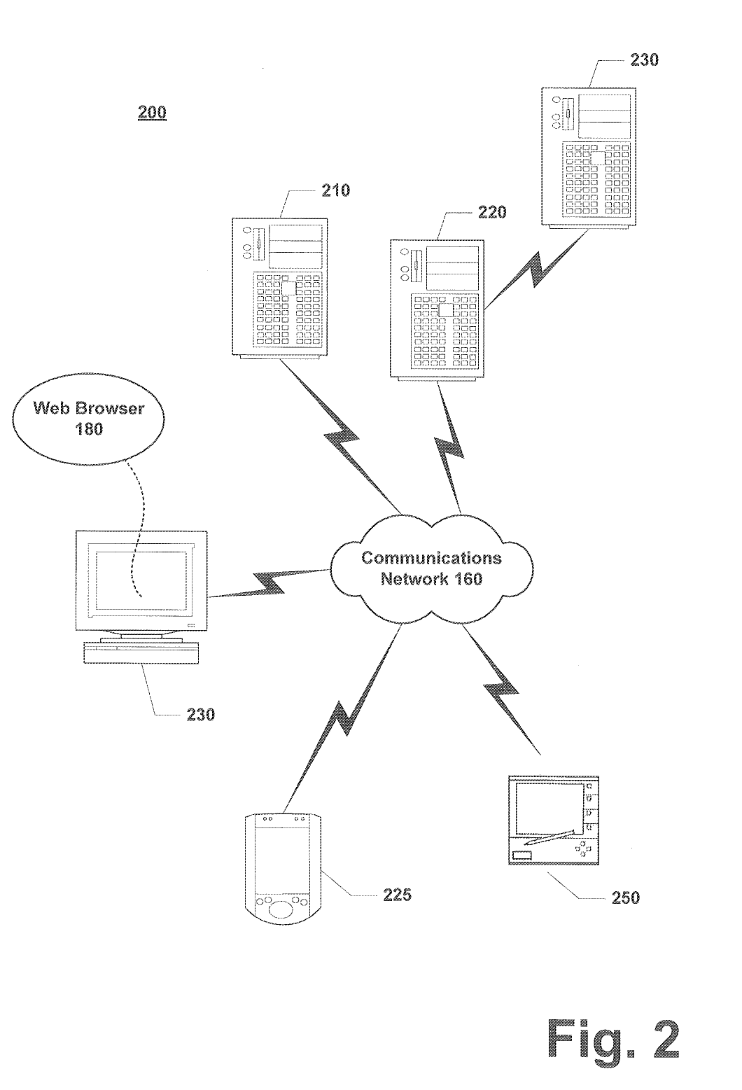

Computing terminal 100 can be deployed as part of a computer network. In general, the above description of a computer terminal can also be applied to server computers deployed in a network environment. FIG. 2 illustrates an exemplary illustrative networked computing environment 200, comprising a plurality of servers in communication with a plurality of client computing terminals via one or more communications networks, in which the herein described apparatus and methods may be employed. As shown in FIG. 2, servers 210, 220, 230 may be interconnected with client computer terminals such as PC 100, smart phone 240, tablet personal computer 250, and the like, via communications network 160, which may include one or more of the Internet, wireless telephone networks, WANs, LANs, and/or other communications networks. In an environment in which the communications network 160 includes the Internet, for example, the clients and servers may communicate using any of a number of known protocols and protocol suites such as hypertext transfer protocol (HTTP), file transfer protocol (FTP), simple object access protocol (SOAP), wireless application protocol (WAP), remote framebuffer protocol (RFB), Remote Desktop Protocol (RDP), cryptographic protocols, and the like. Server computers may be tangible machines, and may also include one or more Virtual Machines (VMs) controlled by a hypervisor, that mimic the operation of tangible servers but which are hosted in a “server farm” comprising a large number of cooperating processors, memory, storage devices, and supporting hardware. An arbitrary number of cooperating tangible servers and server farms hosting VMs can constitute a so-called “cloud computing” environment, in which resources are allocated in accordance with the demands of the tasks at hand.

Each client computing terminal 100, 240, 250 can be equipped with web browser application 180 operable to support one or more computing applications to gain access to servers 210, 220, 230. Client web browsers can include one or more addons, operating to enhance the functionality of the web browser.

In operation, a user interacts with the web browser running on a client computing terminal to obtain access to desired data and computing applications provided by one or more servers, via the Internet. Communications between the servers and the client terminals is accomplished via exemplary communications network 160. A user can use a local terminal to request access to specific data and applications that reside in whole or in part on servers 210, 220, 230 and/or other client terminals 100, 240, 250. The data may be communicated between any of the clients and servers for processing and/or storage. For example, clients and servers, individually or in cooperation with other clients and/or servers, can host computing applications and browser addons for the generation, authentication, encryption, and communication of information to provide services and transactions over the web, and can cooperate with other clients, servers, third party service providers (not shown), network attached storage (NAS) and storage area networks (SANs) (not shown), and the like to realize web services and transactions. The servers 210, 220, 230 may be individual tangible machines, or may be virtual machines (VMs) operating in a cloud computing environment.

Enhanced Web Communication Framework

The information and functionality accessible via the web, generally referred to herein as web content, are available from many different sources. In general, those sources are unrelated and operate independently of each other. Typically, they do not coordinate their content with each other, even when that content is inter-related. Indeed, many providers of web content are direct competitors, more especially if they do focus on related content, and consequently may have competitive disincentives to cooperate. Even if not competitors, each content provider has an individually defined focus, such as providing general information, current events and news, photos, music, video and other entertainment, social interaction, commerce and other transactions, etc. Thus, even if the subject matter of the content available from various providers is related, the providers generally have no incentive to coordinate their offerings, so in general they have not done so. As a result, end users do not receive benefits that are possible from such coordination, such as more streamlined and convenient web interface, enhanced functionality, or a more engaging user experience. They may have trouble locating the specific information and resources they are interested in, and their experience when moving from one content provider to another can be clumsy and frustrating. This can be especially unsatisfying when the subject matter of the content sought is fast-changing and time sensitive. For example, there may be many sources of information available in connection with a quickly unfolding newsworthy situation, and it may be difficult for an interested user to locate and follow those sources. Or, the latest happenings concerning a user's favorite celebrities such as entertainers and athletes, their creations and performances both old and new, communications initiated by them or about them, their personal preferences, products that are related to them, and the like, are quite likely to be accessible from different websites, using different web-enabled applications, some of which may be unfamiliar to a user, difficult to locate, or inconvenient to access, and most or all of which make no attempt to coordinate or cooperate with others.

The herein described addons, systems, and methods form a web-based framework that provides an enhanced web browser user interface enabling a simplified, interactive, coordinated web experience for users. The enhanced interface enables users to interact in real time with images or text presented on any base web page that supports it. The enhanced interface presents a unified front-end with which a user can access any of a plurality of “addon applications”, which allow the user to access videos, news, social networks, storefronts, custom messages and the like, all without leaving the base web page. In an embodiment, a web browser that does not natively support the enhanced interface may be used to access an Internet site, such as a web page or file transfer protocol (ftp) site, that provides an addon that may be downloaded by a user and installed into the browser. Alternatively, a web browser may be modified, such as by the developer of the browser software, to incorporate the herein disclosed enhanced functionality natively without requiring an addon.

In operation, the addon may automatically locate certain information on a base web page without user intervention. In an exemplary embodiment, the addon may be configured to locate and highlight text and images of interest, such as text and photographs that contain the name or image of select celebrities, associate those names and images with browser interface enhancements, and display visual elements that the user can interact with, such as by mousing over an enhanced image, clicking with the mouse on a generated visual element, and the like. The appearance and/or behavior of the enhanced interface elements can be dynamic, and may vary depending on the context and/or in response to specific user and/or automated events. The text and images of interest on a web page may be identified automatically, for example, by analyzing the contents of the page, recognizing in the visible text and metadata of the page the subject of interest, such as by indexing the page contents and comparing the index with a list of subjects in a database, which may be hosted locally or remotely, such as on a server on the web. The layout of the page as currently displayed may also be analyzed locally or remotely, and tags or anchors may be generated with which the addon can place visual elements of the enhanced interface. Those enhancements may be bound to existing elements of the browser or of the web page. Alternatively, the web page may be tagged by its publisher to provide anchors for certain visual and/or functional enhancements. In addition, a mechanism may be provided with which a user can indicate, such as by highlighting using the mouse, text and/or images of interest that are not automatically located. Thereby, the addon can be invoked to provide select functionality associated with the highlighted subject matter.

The addon may generate an icon or other graphical element, such as a button on a toolbar or the like, displayed by default within the browser, that can be used to invoke the display of additional browser elements, for example, to enable additional browser functionality, to make available additional web applications and/or web-based information, and the like. In an embodiment, the button may be used to activate and deactivate the enhancements, or a select subset of the enhancements. In another embodiment, the enhancements may be active by default and the button can be used to invoke select features. For example, the button can invoke the display of a panel containing visual elements that represent data stored in a database, for example, on a web server remote from the client terminal. In the exemplary embodiment that provides celebrity information, the button can be used to invoke the display of a panel anchored on the side of the browser window, referred to herein as a “sidebar”, that can provide user access to a remote database of celebrity images, updated statistics, and other relevant information.

Currently, no web browsers are available that natively support the herein described systems and methods. However, it is contemplated that web browsers and other products may be developed and distributed that do natively support the herein described systems and methods, and will fall within the ambit of the present invention. In a currently preferred embodiment, a user directs a web browser of his computing terminal to a web server, which serves a web page to the client that is displayed in the browser. The web page contains a button or other control with which the user can download an addon to the web browser. As will be appreciated by those of skill in the art, the addon can take many forms. For example, it can be implemented as a computer software application that is hosted in a browser-controlled environment, such as a Java applet. Such applications may also be developed using a procedural programming language such as C, or an object oriented programming language other then Java, such as Visual Basic or C#. Alternatively, the addon may be coded in a browser-supported language such as JavaScript, which relies on the browser to make the addon functional. The addon may be customized as needed to work with different browsers. For example, the type of browser running on the client may be automatically or manually identified, and the addon that is appropriate for that browser may be downloaded onto the client and installed in the browser.

Such addons or collections of cooperating addons can be used to provide many types of browser enhancements, such as new browser screen elements and new functionality. New screen elements can include, for example, dedicated viewing areas, icons, buttons, bars, sliders, spinners, menus, ads, list boxes, and other graphical user interface (GUI) widgets of all kinds, and the like. Such elements may be overlaid on a browser window, and may be used to enhance the appearance and/or behavior of pre-existing screen elements, for example, by automatically or manually detecting the size and location of a select element and binding one or more new screen elements to it. The new screen elements may also be bound to corresponding functions, and may be interacted with by a user to invoke those functions, and/or may have a default appearance and default function. The appearance of such screen elements may be static or dynamic, changing in appearance or behavior in response to events triggered automatically, or triggered by a user action. New functionality can include the display of information, presenting choices, launching applications, user identification, user authentication, user authorization, secure communications, remote control of browser operation, etc. Functions may execute solely on the local terminal on which the browser is running, or in concert with cooperating functional components located remotely on one or more servers and/or other clients.

In an exemplary implementation, included with the herein described addon, or provided in an auxiliary addon, “top line” and “sidebar” interactive browser interface elements may be provided. The interface elements may allow for real-time interacting with base web page text and media enhancements and/or sidebar elements described herein. The interface elements may also allow for real-time interacting with a subject of the enhancements, and/or with the concurrent real-time browsing of the subject, such as a celebrity or other person of interest to the user. As used herein, a top line interface includes at least one indicator widget, such as a button, banner, bar, or the like, preferably visually proximate to the domain listing location or navigation toolbar in a web browser interface, or the top bar or standard toolbar in an application interface. A top line interface, as used herein, stands in contradistinction to a sidebar interface, as also referenced herein. For example, a sidebar interface may serve to aggregate data such as browsing data, from which information of interest may be gathered, whereas a top line interface may serve to provide alternative or enhanced browser or application functionality.

Moreover, a celebrity may poll current viewers, or a subset of viewers such as designated followers, through the top line interface, with regard to a participation of the celebrity in an activity, or the like. For example, a female celebrity may shop for dresses, and may poll her followers regarding which dresses the followers prefer, or which they would like the celebrity to wear to the Oscars, or the like. Similarly, the celebrity may invite users to the celebrity's social webpage, for example wherein the celebrity actively does research regarding a role the celebrity has been offered. In such an exemplary scenario, the celebrity may poll followers as to whether the celebrity should accept the role.

For example, the top line interface may provide a ticker that shows when one or more personalities are currently on-line, thereby allowing followers to participate in an experience related to any personality that the viewer follows. The indication in the top line interface of which personalities the user wishes to follow may be set, for example, from a search, or from the tracking of user preferences, for example, such as by tools accessed via the sidebar. Likewise, a ticker in the top line interface may indicate what site, or what activity or the like, is presently being viewed or will soon be undertaken by a particular personality.

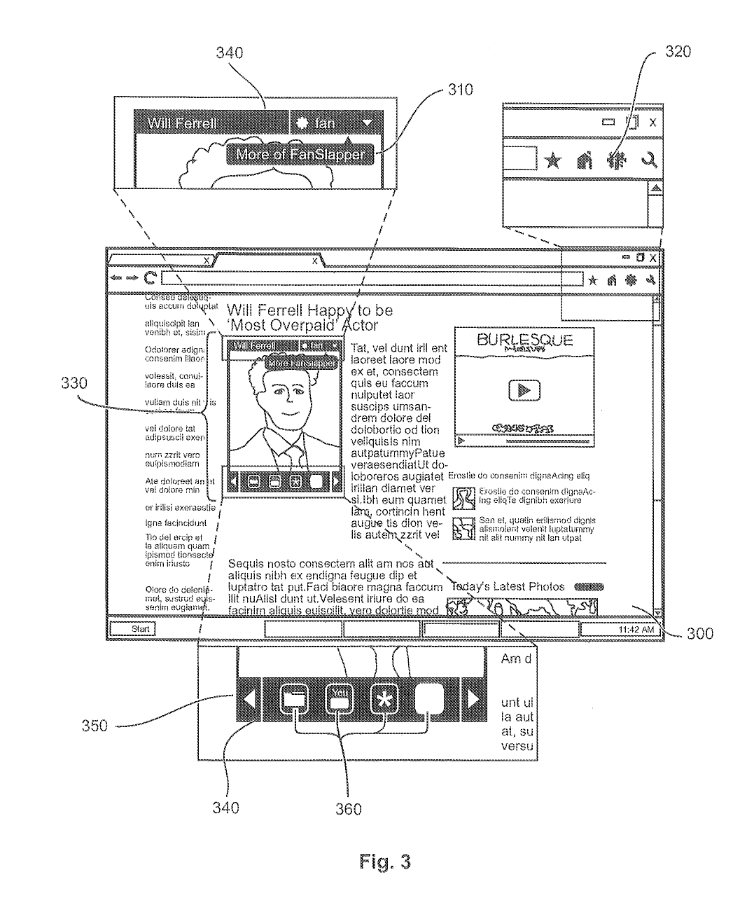

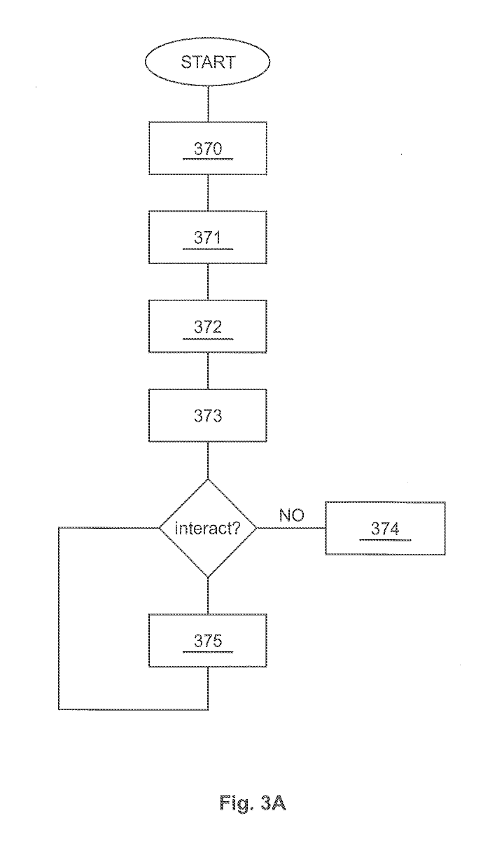

FIG. 3 is a screenshot showing elements of a currently preferred embodiment of an enhanced browser interface in accordance with the herein disclosed systems and methods, with zoomed enlargements of the enhancements. As shown, the addon generates new graphical elements and places them on the browser. Tips 310 may be displayed to help the user become familiar with the graphical elements added by the addon to the browser. Such tips may be displayed automatically, in groups or individually in a predetermined sequence, or in response to a user hovering a mouse over an added element, or the like. The addon automatically generates enhancements to select elements of the web page being viewed in the browser. In a currently preferred embodiment, the enhancements can be configured by default to be directed to text and images pertaining to celebrities such as entertainers, sports figures, and the like, although the invention is not so limited, and may be used to enhance one or more other sets, subsets, or supersets of entities pertaining to any predetermined subject matter.

As shown, in the currently preferred embodiment the addon generates a button 320 and places it on a toolbar of the browser. The button is used to invoke the appearance of a “sidebar” that covers a portion of the browser window, as will be described later. The addon also generates other visual enhancements to elements of web pages in connection with the predetermined subject matter, such as celebrities. In a currently preferred exemplary implementation, at least three types of enhancements may be added to a web page, referred to herein as a full enhancement, a thumbnail enhancement, and a text enhancement.

In the exemplary implementation, a “full enhancement” is added to images 330 of celebrities that appear on the web page being viewed, wherein the images are at least as large as a predefined height and width in a preferred measurement system, such as in pixels. The full enhancement may provide a “title bar” 340 across the top of the image that identifies the subject displayed, and/or a “dock” area 350 across the bottom of the image that contains icons 360 for launching select ones of a plurality of “addon applications.” The dock may also contain controls 370 that allow the user to scroll through the addon application icons on the dock. The user can launch a desired addon application by clicking with the mouse on the corresponding icon 360 in the dock area. The addon application then launches and presents its contents within the boundaries of the image, filtered or customized to pertain to the celebrity that is the subject of the image. Preferably, if the image is smaller than a predefined size, the addon application is launched in an addon display area of a predetermined size, superimposed over the image. Preferably, the display area displays a predetermined portion of the image resized for display in the display area, although other presentations may be used, such as cropoped, stretched and/or tiled images.

In a currently preferred implementation, the addon applications access and present information that resides on remote servers, and can include applications that mimic the appearance and operation of corresponding full web-based applications such as Google, Wikipedia, Youtube, Twitter, Facebook, and the like. The appearance and operation of the full web-based applications may be mimicked in the corresponding addon applications such that the user experience using the addon application is similar to the user experience using the full web-based application, even though the addon application operates within the boundaries of the addon viewing area.

FIG. 3A illustrates an exemplary background methodology performed by a server that provides the media enhancements of FIG. 3, and as discussed hereinthroughout. As shown, the addon, such as the browser-embedded javascript and/or widget, loads and assesses user preferences and any known persons in pictures or text on the viewed page, at step 370. For example, “look and feel” preferences may be set by the user, or by a person to be featured in the enhancement. Additionally, different versions of the enhancement(s) may be served based on the domain, browser type, and/or IP address, by way of non-limiting example. Similarly, page preferences may be assessed, such as by application of page publisher rules at step 370. Further, by way of example, any known methods may be used to assess who is on the page, including metadata, context, page text and headings, and the like. The javascript than calls for the server to load the “app experience” for that person, if there is a suite of apps indicated by that person, such as personalized apps, or to load the general “app experience,” i.e., the typical suite of apps loaded for the enhancements, at step 371. Thereafter, at step 372, the advertising experience is loaded, i.e., any sponsored ads related to the person on the page, any contractual ads related to that person, or the blockage of any ads specifically indicated as not relating to that person.

Of particular note, the ad experience at step 272 may vary based on any number of factors. For example, users who have affirmatively downloaded the addon may receive an ad a certain predetermined percentage of use time, which may be less of a percentage than ads are produced to users who did not download the addon (i.e., publisher side users). Likewise, particular users may receive an ad only upon first production of an enhancement window by the addon, or only upon first, or first and second uses of the addon, by way of non-limiting example. Similarly, ads may not be produced inside the enhancement window at any point, and/or may be provided only at a certain location, or only for a certain time, in the enhancement window, or ads may be randomly produced a certain portion of the time, by way of non-limiting example. Yet further, ads may be produced only for unrecognized image subjects on the page, or only in relation to enhancements to a certain percentage of unrecognized images, for example. Of course, ads produced that do directly relate to an image may be premium advertisement inventory, such as may be subject to enhanced ad-placement rates akin to endorsements for the advertised product or service by the subject of the image.

At step 373, the featured apps of the loaded app experience, and the featured ads for the ad experience, are loaded from the server, and the app experience is displayed to the user. Certain apps may automatically run for all enhancements, such as referral apps or mini-apps for Facebook and Twitter for a celebrity. Thereby, for example, a celebrity may inject content for interaction with users when those users land on a page featuring that celebrity, via the enhancements. For example, singer Katy Perry may comment on an article about her in people, and that comment may be injected when her enhancements load on the People magazine page (or on an unrelated page), or when people mouseover a People magazine app loaded in relation to Katy Perry, by way of non-limiting example. Thereby, the media enhancements of the present invention may provide a consolidation of content related to a person, including content created by that person, within the enhancement window/topline/sidebar of the present invention. If the user does not interact, such as via mouseover, with the app experience, the app experience, and/or the enhancements generally, may fade away at step 374.

If the user does interact in a predetermined manner at step 373, the ad experience loaded may be displayed to the user at step 375. The ad experience may include a number of ad units, in time or location, for display in relation to the enhancements. The ads may include, for example, goods endorsed by the subject of the page, banner ads, pop-up ads, sponsored ads, and the like. Needless to say, if the user interacts with an ad, an app experience related to that ad may load, or the user may be redirected to a page of the advertiser, either within the enhancement only or within the browser generally, by way of non-limiting example. Finally, if user interaction does not occur with ads or apps over a certain times frame, the enhancements may be faded at step 377.

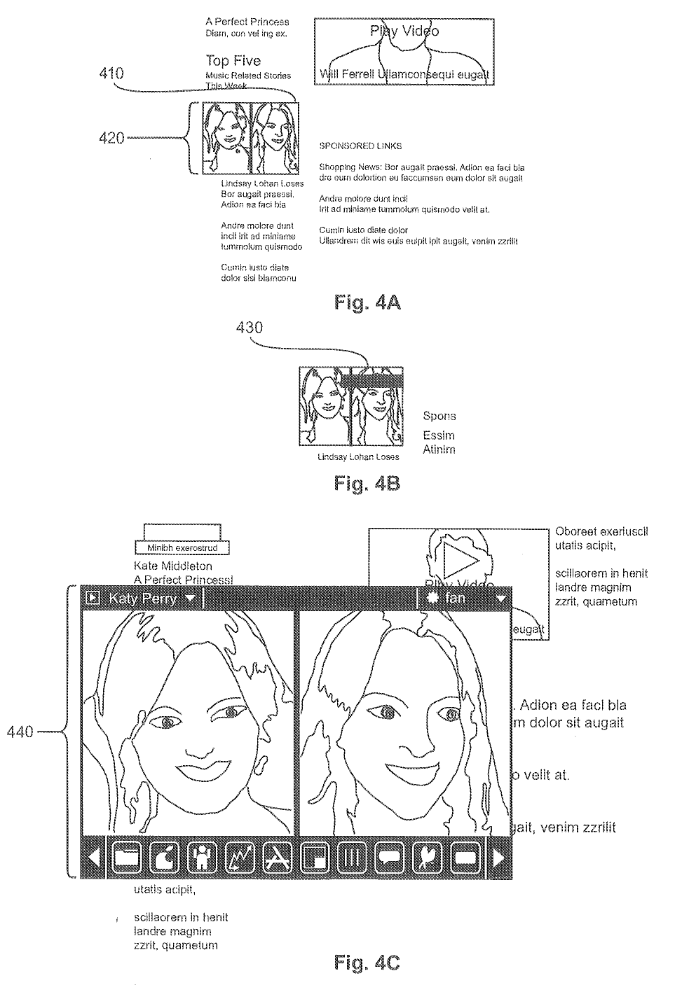

A “thumbnail enhancement”, illustrated in FIG. 4A, may comprise only a small graphical element 410 such as a logo that may be superimposed on images 420 that are smaller than a predefined height and width, i.e., thumbnails, and are thus too small for the full enhancement to be displayed. Hovering the mouse over the logo may display a tip or other modification of the logo, 430. Clicking on the logo expands the thumbnail image to fill a larger rectangular area of the screen 440 superimposed over the portion of the screen originally occupied by the thumbnail. The larger area has a predefined size and displays a full enhancement in the enlarged thumbnail area.

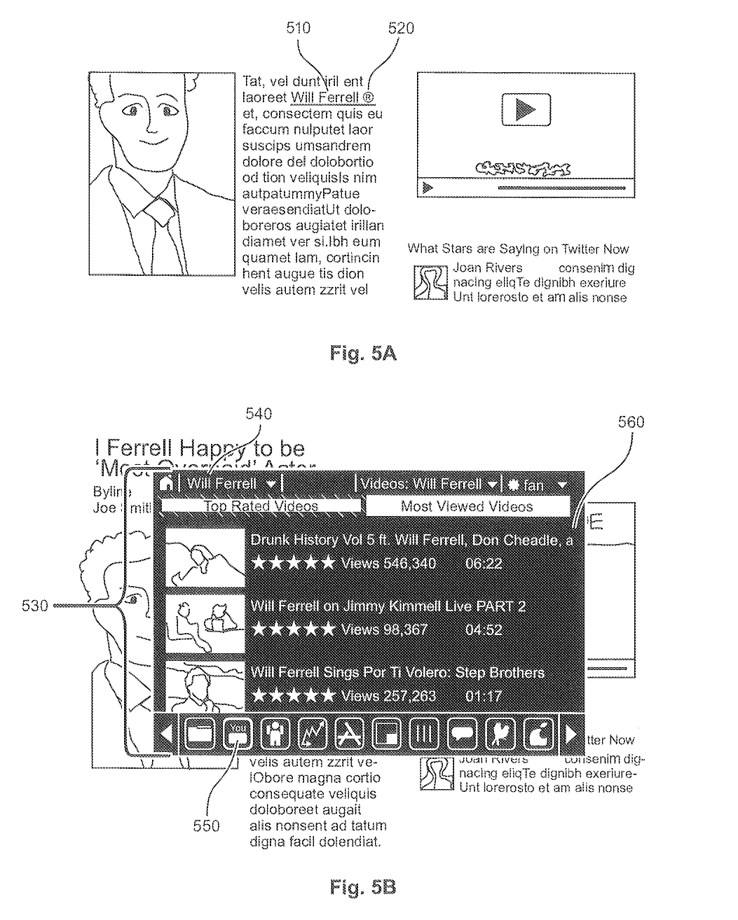

As shown in FIG. 5A, a “text enhancement” may highlight select text such as celebrities' names 510, and/or may generate an addon logo 520 adjacent to the select text. As shown in FIG. 5B, clicking on the highlighted text of logo generates an addon display area 530 that is preferably, but not necessarily, a rectangle of the same size as that generated in the thumbnail-based full enhancement, placed at a predetermined position in relation to the highlighted text and/or the text's position in relation to the borders of the browser window or viewable area. A full enhancement is displayed in the rectangle. Preferably, a default or preselected application is launched in the addon display area, since there is no underlying image to display.

The title bar across the top of the full enhancement display area preferably comprises several functional elements, or widgets. In the preferred embodiment, an identifier (ID) widget displays an identifier of the subject of interest, such as the name of a celebrity, 540. When an addon application is launched by clicking its icon in the dock, the addon application accesses the content of the corresponding full web-base application, and the contents are automatically filtered to obtain content that pertains to the identified celebrity. For example, as shown in FIG. 5B, clicking on the Youtube icon 550 in the dock area launches the Youtube addon application, which accesses the full web-based Youtube content, and which appears and operates much like the full web-based Youtube web site. In a currently preferred Youtube addon application, in the addon viewing area a list is presented of Youtube videos that are the result of a search of content hosted by Youtube on the name of the identified subject of the image. Additional functional elements relevant to the contents of the addon display area are also provided. For example, a vertical scroll control 560 is provided to scroll through the search result list of Youtube videos. Clicking on a select video from the list invokes the video to play in the viewing area, although other video presentations are possible, such as playing the video in its own frame in the foreground, which may be resized by the user, such as by dragging a border of the frame. The addon application may also present other controls similar to those of the full web-based application, and which result in a user experience that mimics that of the full web-based application. In the Youtube addon application for example, in a mouseover of the video while it has the focus, controls may appear that pertain to controlling the playing of the video, and that are specific to the Youtube addon application. For example, controls such as the play control, the volume control, the timer control, etc., may appear, similar in appearance and functionality of those presented in the full Youtube web site

Thus, a user experience is provided within the Youtube addon viewing area that is very similar to that provided by the full web-based Youtube application. The content is still provided to the addon application by the actual Youtube site, but without the user having to leave the base web page, navigate to Youtube, and search its contents for the subject of interest, in order to access items of interest in the search results list. Modifications can similarly be made to other addon applications corresponding to other full web-based applications. The addon applications access content from the corresponding full web-based applications. The addon applications have controls that appear and behave similarly to those of the corresponding full applications, but are accessed within the addon display area without leaving the base web page. In effect, the addon applications are designed to provide a user experience within the addon display area which is quite similar to that provided by the corresponding full web-based application.

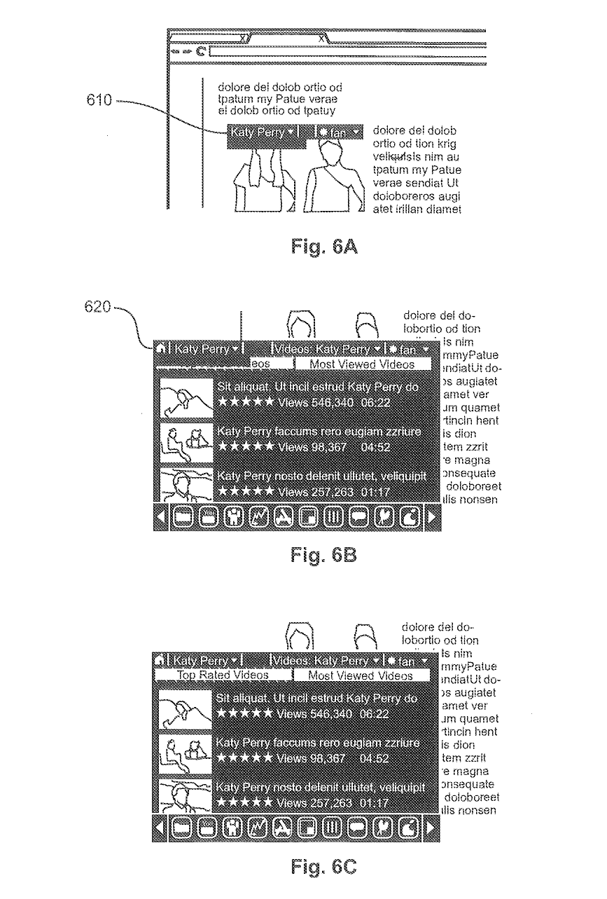

As shown in FIG. 6A, in the case where more than one celebrity (or other subject) is identified in the ID widget as being present in the image, the widget may provide a drop-down list 610 with which a user may select a particular celebrity of interest. When an addon application is already running in the addon display area, as in FIG. 6B, the subject of the web-based content filter is changed to the celebrity most recently selected from the list 610, and the content of the addon application in the addon display area is revised to pertain to that celebrity, as in FIG. 6C. A different application can be launched and the currently running application can be terminated by clicking the icon of the new addon application on the dock, and the subject matter of the web-based application corresponding to the newly selected addon application will be filtered to pertain to the same celebrity and presented in the addon viewing area.

Thus, a user can select a subject of interest identified by the addon from a small or large image or text of a web page, and with a single mouse click launch any of a plurality of addon applications to run within the addon viewing area, search or filter corresponding web-based application content based on the selected subject, and present the search results in the addon viewing area, all without leaving the web page. With another click, the user can then switch the contents of a running addon application from one identified subject to another. A single click on the icon of a different addon application on the dock closes the present addon application, launches the addon application, searches the contents of the corresponding full web-based application based on the already-selected subject, and presents the search results in the addon display area, with controls that mimic the operation of the full web-based application. Thereby in effect, the addon provides a unified browser experience not possible in the prior art.

Preferably, if a user does not interact with the image containing the title bar and/or dock, the title bar and dock cease to be displayed, as referenced above with respect to FIG. 3A, and an addon logo is superimposed on the image to indicate that the addon functionality is available in connection with that image. Thereafter, the user's browsing experience is only minimally affected by the addon. Preferably, the title bar and dock reappear when the mouse hovers or passes over the image.

A “control widget” 620 controls the display of the addon viewing area. When an application is running in the viewing area, the user can click on the control widget to close the application and return to the default appearance of the viewing area. From the default appearance of the viewing area, the user can click on the control widget 620 to deactivate and close the viewing area.

Depending on the application and the function selected, clicking on an addon application control within the viewing area may launch the full web-based application in a new tab or window. For example, an addon storefront application such as Amazon, when launched from the dock, presents in the addon viewing area the result of a search of Amazon.com content based on the subject of the image or text selected. In the addon display area, the user can interact with the Amazon addon application, for example, to scroll through the search results. However, selecting one of the items in the search result, such as to get more information or to purchase the item, launches the full web-based Amazon.com storefront in its own browser tab or window, where the user can complete a purchase of the selected item, find additional information of the item, and generally use the Amazon.com storefront in the usual manner. Meanwhile, the original base web page continues to be available in its own tab or window.

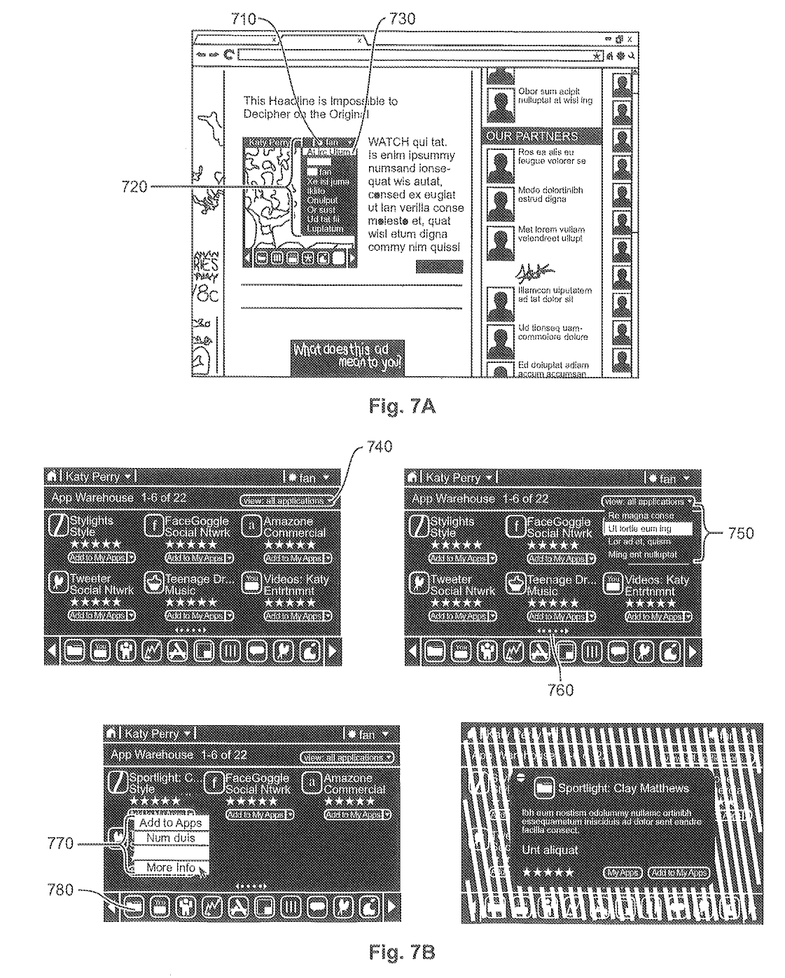

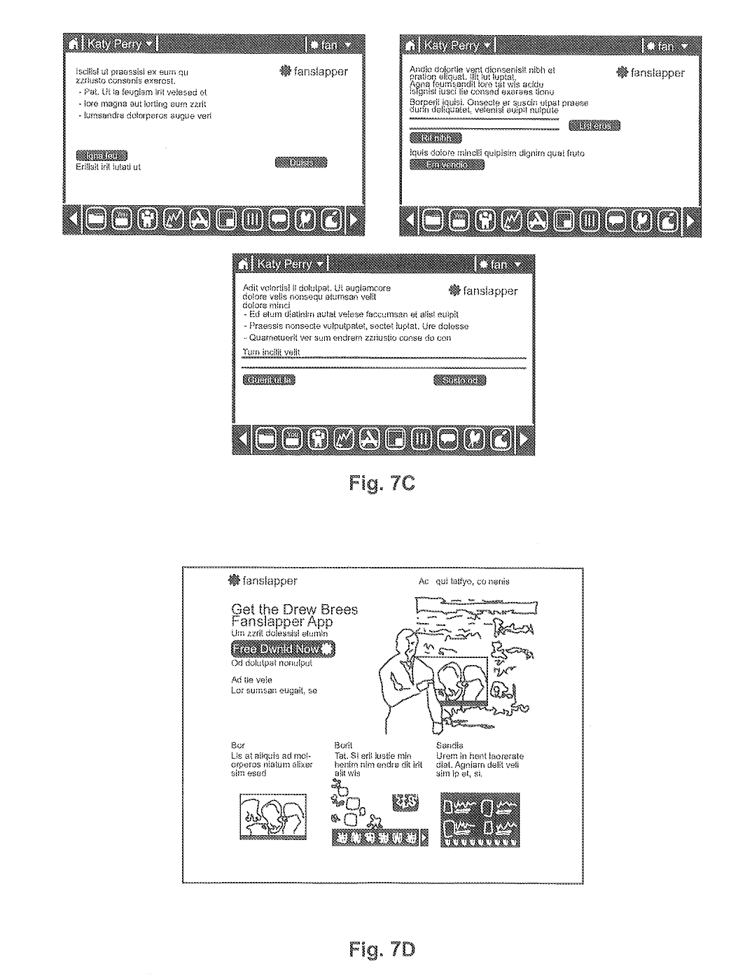

As shown in FIG. 7A, clicking on a menu control widget 710, preferably disposed on the right side of the title bar of an addon full enhancement, causes a menu of addon offerings 720 to be displayed. In an exemplary embodiment, the addon offerings 720 include: App Warehouse; share on Facebook; share via email; Get mobile application; For Publishers; For Advertisers; For Developers; About the addon; and Share Your Feedback.

The App Warehouse menu item 730 when clicked causes an addon display area to be generated that shows a list of available addon applications, as shown in the top left of FIG. 7B. In a currently preferred implementation, the display area includes a “view applications” widget 740 that presents a scrollable list of predetermined categories of addon applications 750 as shown in the top right side of FIG. 7B. Preferably, all available addon application icons are displayed by default, including the applications whose icons appear on the dock, as well as one or more additional applications whose icons do not appear on the dock. Selecting an application category from scrollable list 750 filters the displayed applications, and shows only those of the selected category. In the currently preferred implementation, categories include Sports; Social Networking; eCommerce; Entertainment; Reference; News; Games; Lifestyle; and Education, although more, fewer, and/or different categories may be used.

As shown, each listed addon application includes a representative icon, application name, category, user rating, and a gadget that presents a drop-down list of options, 770, as shown at the bottom left of FIG. 7B. Currently, those menu items include “Add to My Apps”; “Launch App”; and “More Info”, although more, fewer, and/or other menu items may be used. Clicking on Add to My Apps adds the icon of the selected application to a collection of applications selected by the user. That collection may be accessed at any time from a “My Collection” icon 780 on the dock of any addon full enhancement display area. Thereby, the collection of addon applications selected by the user is easily accessible directly via the My Collection dock icon. The Launch App item launches the application, which can alternatively be launched by clicking on the addon application icon. The More Info item displays information of the application, as shown at the bottom right of FIG. 7B. A scroll widget 760 allows the user to scroll through the applications contained in the application warehouse.

Returning now to the menu of addon offerings 720 of FIG. 7A, clicking on the Share on Facebook menu item automatically posts to the user's Facebook page (if the user is logged in to his Facebook account) the image being viewed. Preferably, if the user is not logged in to his Facebook account, the user is presented with a page to enter his login credentials. Once the image is posted, the user's Facebook friends have access to the image. Accessing the image from Facebook allows the user's friends to reproduce the same addon state the user's addon had when the image was posted, if they also have the addon installed on their own local computing terminal.

The Share via Email menu item provides via email functionality that is similar to the Share Facebook item. The Download Mobile Application launches a web storefront such as iTunes or the like, from which the user can download a version of the addon for use with a mobile device, such as an iPhone or other iOS device, smart phone or other Droid device, or the like. The About the Addon menu item invokes the display of information regarding the addon. In a currently preferred implementation, the information may includes the addon's developer, owner, and/or operator, links to legal documents such as terms of use, privacy policies, and the like, and information identifying pertinent intellectual property such as patents, copyrights, and trademarks, and the like.

The For Publishers menu item provides information, or links to information, that may be of interest to web page publishers, such as web site developers, operators or the like. As shown at the top left of FIG. 7C, benefits to web publishers can include providing more engaging and exclusive content, resulting in users spending more time viewing their web pages. Users lingering on a web page can increase the value of the page in terms of it being a platform to deliver advertising and premium content. In effect, the longer users remain focused on a page, the more valuable that page may become to an advertiser or the like.

Similarly, the For Advertisers menu item provides information, or links to information, that may be of interest to advertisers. As shown at the top right of FIG. 7C, celebrity related content is among the most desirable and engaging on the web. Therefore, aspects of the herein described systems and methods are of interest to advertisers because they can better align their offerings with content that consumers find most interesting, driving consumer engagement with the advertised brand. In a currently preferred embodiment, the herein described systems and methods can be coordinated with offerings from Brand Affinity Technologies (BAT) to deliver extremely focused, localized, and timely advertising and promotional content.

The For Developers menu item provides information, or links to information, that may be of interest to application developers. As shown at the bottom center of FIG. 7C, the herein disclosed systems and methods can be made available to developers to build applications around engaging celebrity content. In a currently preferred implementation, application development tools may be provided to approved developers allowing them to develop applications that integrate into a web environment that is agnostic to the type of computer terminal a user has, and can provide widespread exposure to an application at the precise moment it is relevant to potential users. In a currently preferred implementation, approved applications provided by developers can be included in the previously disclosed application warehouse. Applications may generate revenue in any of a number of ways, such as charging for the application, charging for its use, and/or generating other revenue streams related, for example, to transactions that are enabled or supported by the applications. The revenue can be retained by the application developer, or shared among select participants in transactions resulting from use of the application, or the like.

As shown in FIG. 7D, such applications may be made available for download from an application specific download page. Such a page may include a control whereby the application may be downloaded for installation on a user's computer terminal, and information relevant to the operation, usage, and benefits of the application.

In an embodiment, the addon display area as hereinbefore described may include one or more RSS feeds from any of a variety of sources. In a currently preferred embodiment, for example, a scrolling Twitter feed may be provided that conveys the most recent tweets of the select celebrity, preferably below and adjacent to the title bar. The scrolling information can include the text of the tweet, the time and date that it was sent, and a Twitter logo. Preferably, the Twitter feed appears for short periods of time, such as for ten seconds, at longer intervals, such as every two minutes. When clicked, the Twitter icon on the Twitter feed launches a Twitter addon application which has the look and feel of the full web-enabled Twitter web page, and enables the user to interact with Twitter without leaving the base web page.

In an embodiment, the full enhancement of an image can include a “shopping” widget that pertains to products that are identified in the image. For example, an image of a celebrity wearing a certain set of clothing and accessories may include a shopping widget overlaid thereon. When clicked, the shopping widget launches a shopping addon application that lists or displays items identical or similar to those that appear and are identified in the image. Clicking on a listed item preferably launches a full web-based storefront from which additional information of the displayed item may be found and/or the item may be purchased.

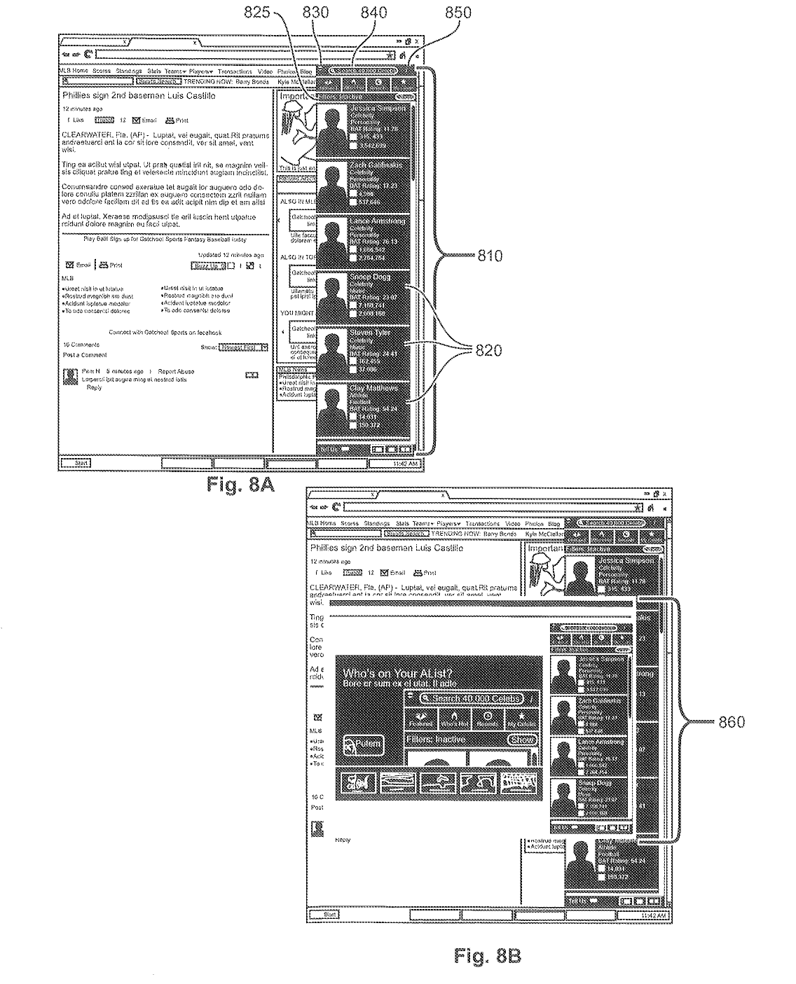

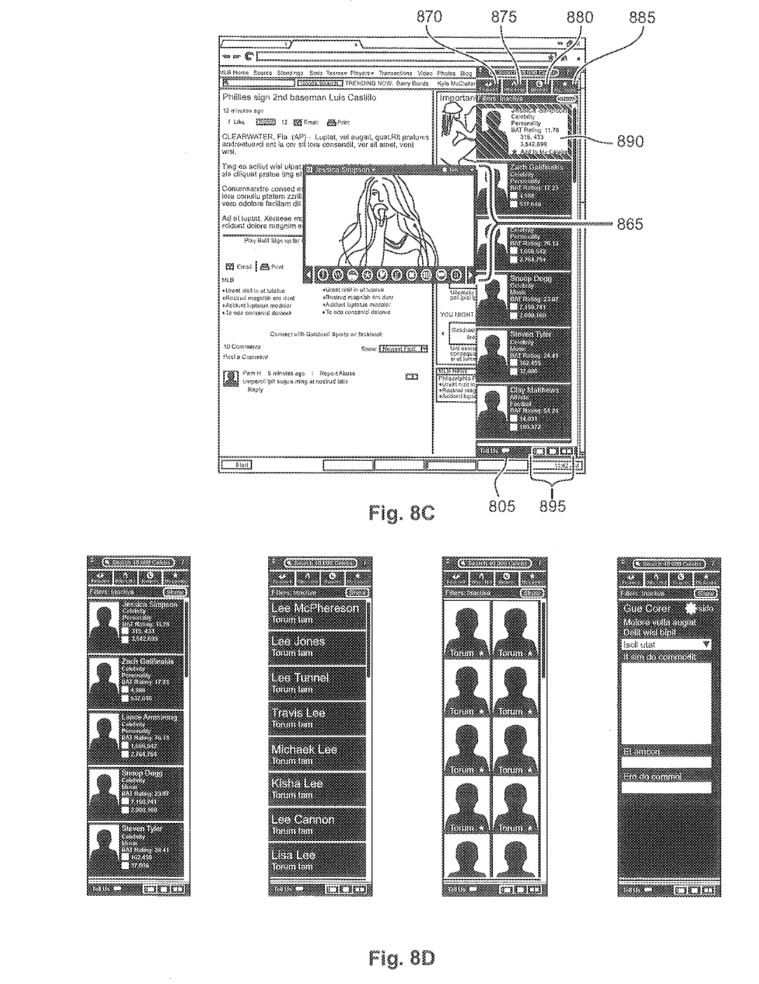

As shown in FIG. 8A, clicking the addon button 320 on the browser toolbar invokes the display of a panel 810 at a default location within the browser window. In a preferred embodiment, the panel appears superimposed over the right side of the browser window, and is referred to herein as a sidebar, although other presentations are possible, such as a frame floating in the foreground. The sidebar displays content that may remain constant as the image and text enhancements described in the foregoing are used. Preferably, the appearance of the sidebar is consistent across any web page that supports the addon and is being viewed when it is launched.

The sidebar presents a predetermined selection of celebrities or other subjects, each one in a “subject block” 820. In an embodiment, the subject blocks display a predetermined subject image, name or identifier, category (such as celebrity, athlete, and the like) and subcategory (music, football, etc.) information. The subject blocks may also present other information such as statistics of various kinds. In a preferred embodiment, the statistics displayed can include a celebrity rating as developed by Brand Affinity Technologies (BAT) that may indicate the celebrities' popularity, approval ratings, and the like. Other statistics may be presented as well, such as the number of facebook and/or twitter followers the subject has, and/or information of usage of the addon by users. Such statistics can include instantaneous numbers (e.g., number of users currently online and focused on that subject), or aggregated over a select time period, or statistically analyzed and/or combined with other information in any desired manner. Preferably, the information displayed in the subject blocks is generated remotely and provided by a server in communication with the local client. Although a particular arrangement of the contents of the subject blocks has been described, other arrangements are also possible. For example, the information displayed may be modified based on a particular context.

The sidebar may also display one or more widgets or its own. For example, a filter widget 825 may be provided to filter the celebrities shown in the sidebar by any of a variety of filtering criteria (not shown). Display of the criteria available to search on may be toggled on and off by clicking the widget. A close widget, 830, may be provided to close the sidebar. A search widget, 840, may be provided to search the online database from which the celebrity information shown in the subject blocks is provided, so that a user can search for a particular celebrity of interest. An addon information widget 850 may be provided to display information pertaining to the addon. In a currently preferred embodiment, clicking on the addon information widget 850 launches a new browser window 860 floating in the foreground, containing an exemplary sidebar and explanatory information, as shown in FIG. 8B.

As shown in FIG. 8C, clicking on a select subject in the sidebar invokes the previously described full enhancement in a frame that extends from the center of the left edge of the sidebar, 865, although other positions or behavior may be used. The full enhancement presents within its viewing area the same capabilities described hereinbefore. Such a frame also extends from the sidebar when the search widget 840 is used to select a celebrity, if information of that celebrity is included in the celebrity database.

Other widgets that may be present in the sidebar include a “featured” widget 870 which, when clicked, displays in the sidebar a predetermined set of subject blocks of featured celebrities in a predetermined order. A “who's hot” widget 875 when clicked presents a collection of subject blocks of celebrities in order of their ranking in accordance with a preferred or select measurement or statistic pertaining to the celebrities whose information is stored in the remote database. A “recent” widget 880 accesses a locally or remotely stored list of celebrities that were most recently selected to be the focus of addon functions, and displays the subject blocks of those celebrities, preferably in descending order with the most recently viewed celebrity at the top of the list. A “My Celebs” widget 885 displays the subject blocks of celebrities selected by the user for inclusion, such as the user's favorite celebrities. Celebrities are selected for inclusion in the My Celebs list by clicking on the “Add to My Celebs” control that appears in a selected subject block, 890.

A plurality of “display widgets” 895 may be displayed, preferably at the bottom right of the side bar, that can be clicked on by the user to change the appearance of the subjects listed in the sidebar. For example, one display widget can be clicked on to display the subject blocks as described previously, as shown in the left side of FIG. 8D. A second display widget may change the layout of the subject blocks to display only the names and categories of the same subjects in the same order, as shown in the left center of FIG. 8D. A third display widget may change the layout and arrangement of the subject blocks to include only a thumbnail image and the name of the celebrities arranged in a double column, as shown in the right center of FIG. 8D. Other widgets may also be provided that change the layout and contents of the subject blocks in the sidebar.

A “feedback widget” 805 can also be provided, preferably disposed at the bottom left of the sidebar. Clicking on the feedback widget presents a form in the sidebar for sending comments for use by the addon developer, such as to improve the operation of future versions, add customizations, and otherwise modify the appearance, functionality, and/or operation of the addon. A currently preferred form is shown in the right side of FIG. 8D, although other forms may be used.

Using the foregoing described systems and methods, any number of addon applications can be launched in the addon viewing area, to run one at a time, by clicking their corresponding icons in the dock. Each application will summon content from corresponding resources accessible via the Internet. Thus, addon applications as Twitter, YouTube, Amazon, various Google applications such as news and images, and others may be launched and presented in the addon viewing area, each one searching the corresponding full web-based application data for content pertaining to a selected subject of interest, presenting the search results with controls similar to the full application, without a user leaving the original website.

In addition, new applications may be developed that are specific to the addon and have no full web-based version. Such applications may present or make use of metrics, such as positive or negative mentions for a celebrity on the web, in print, on tv, and the like, pertaining to the celebrity or other subject of interest, for example.

In addition to the control of the addon viewing area effected by the user using the local computer terminal, additional control may be provided remotely, from a server or another client terminal. Such remote control may require permission of the local user, and/or may depend on the context. For example, the local user may grant permission to a remote user on a remote computer terminal to communicate with and/or control the local terminal. Control of the local terminal may be passed between the local and the remote user. The control of the local terminal may be exclusively by the local user or by the remote user, or both local and remote users may share control of the local terminal concurrently. Further, a user may broadcast local content to a plurality of remote terminals.

The addon may automatically or in response to user actions access services on remote servers, such as authentication services, encryption services, for example, in accordance with a public key infrastructure (PKI), financial services, and the like. Financial transactions may be effected, for example, by communicating with cooperating financial institution servers, in association with content being viewed or interacted with on the local terminal via the addon. In an embodiment, the operation of the addon may be remotely detected and analyzed to develop a profile of user preferences, which may be used to modify the operation of or otherwise enhance the appearance and/or functionality of, or enabled by, the addon.

The foregoing systems and methods constitute a framework that may be used to generate revenue in various ways. For example, advertisements may be presented, either within or outside of the addon viewing area, such as discussed above with respect to FIG. 3A. Such ads may be selected in accordance with, coordinated with, or otherwise influenced by the operation of the addon. For example, ads can be displayed that are relevant to the user-selected subject, and/or the user selected application running in the addon viewing area. Advertisements may be presented a limited number of times, and/or for limited duration, and/or only in response to a particular instantiation or select instantiations of a widget and/or addon application. Ads may be relevant to and/or triggered by an identified subject of an enhancement, or may be relevant to and/or triggered by a characteristic of the base web page, such as its domain. For example, ads may be delivered by an addon in response to a user browsing people.com, but not necessarily related to any particular identified subject. Ads may also be delivered in association with images and/or web pages that do not contain any identified subjects at all. Further, select ads may be delivered to users based on their user preferences and/or their browsing patterns.

It is generally accepted that advertising and/or creatives (hereinafter referred to as “ads,” “creatives,” or “content”) having the highest impact on a desired consumer base includes endorsements, sponsorships, or affiliations from those persons, entities, or the like whom the targeted consumers trust or respect; or from whom the targeted consumers seek guidance, or about whom the targeted customers seek news. As such, the desirability of providing content, such as an endorsement, ad, or other content enhancement associated with a particular field of endeavor, may be based on one or more of the endorser's knowledge of particular goods or a particular industry, the frame of the endorser, the respect typically accorded the endorser or his sponsor, the use of the endorser in association with news, gossip, or the like, and other similar factors. As used herein, such content may be provided, for example, in association with content pertaining a particular good or service, an actor, athlete, or other famous person, a subject or creator of an artistic, audio, visual, and/or audiovisual work, and/or an actual endorsement of the use of a product.

In an embodiment, the herein disclosed systems and methods provide a platform or engine to allow for the querying, such as by searching and/or requesting, for content associated with a celebrity or “talent,” or other subject, or a brand or the like, and may result in a manually or automatically generated recommendation of content responsive to the query. The platform or engine also provides for the fulfillment or delivery of the content, such as in association with other primary content. The primary content may be, for example, identified content of a base web page being viewed by a user. In an embodiment, the delivery of the content to the user may be in the form of, or responsive to, a widget that operates to provide additional, secondary content that enhances the primary content.

More specifically, and as illustrated in FIG. 9, the system 905 of the present invention may provide a query engine 910, whereby a user may inquire, such as by a search or request, for potential endorsers or other subjects fitting certain categories, and/or for content associated with particular endorsers and/or fields of endeavor, such as sports figures, actors, and the like. The present invention may further provide a recommendation engine 912, which may be and/or include a server 913, such as an endorser information server, wherein the recommendation engine returns results responsive to the inquiry entered via query engine 910. Finally, a fulfillment engine 914 may enable the content for delivery, such as preparing the content returned by recommendation engine 912 in a particular template, format, widget, or the like.

Thus, query engine 910 may have a search interface, a list interface, a series of selectable drop downs, a request for enhancement received from a third party, or the like. Recommendation engine 912 may include, and/or have accessible to, a content vault 920, such as online data storage and/or a database that may be secured, and storing therein a plurality of creatives and other digital content categorized and associated with one or more celebrities and/or brands. For example, content in the vault may include text, such as quotations, audio files, video files, picture files, highlights, or the like. Such content may have limited availability, for example, may be available only from the vault, and may be categorized by time, location, product, context, service, or the like. The recommendation engine may additionally generate and/or accumulate metrics, which may be associated with subject matter stored in the vault. Consequently, the recommendation engine may provide scores, rankings, or the like.

The fulfillment engine 914 may provide one or more templates for the creation of sponsored advertisements, or for the association (such as by “mashup”) of content stored in the vault with content from other sources. For example, content available from a base web page produced by a web publisher (“primary content”) may be combined or otherwise associated with content from other sources as “secondary content.” The “secondary content” may be provided by the fulfillment engine for delivery, for example, to viewers of the base web page. The fulfillment engine may formulate, or may direct the formulation by a third party, the secondary content for use with a widget enhancement, in accordance with the herein disclosed systems and methods.

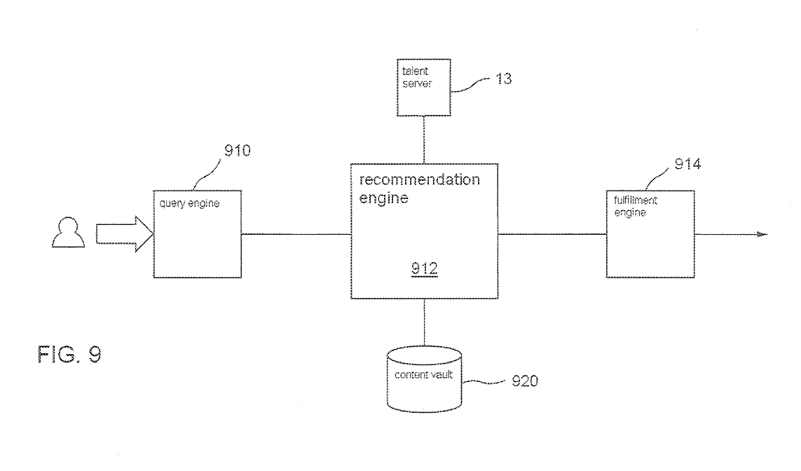

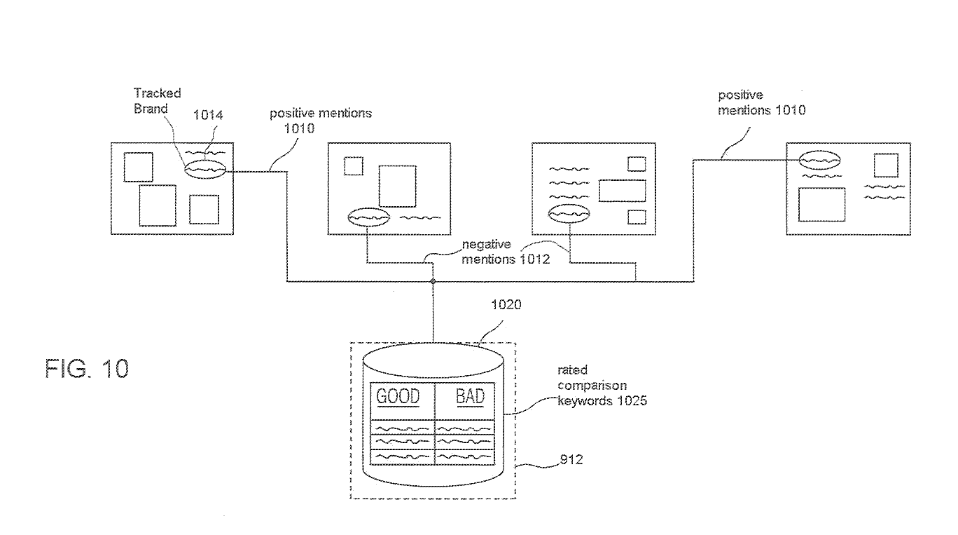

As referenced previously, the recommendation engine 912 may provide metrics for sponsoring brands and talent. Such metrics may be gauged in any number of ways, certain of which will be apparent to those skilled in the relevant arts in light of the disclosure herein. For example, as illustrated in FIG. 10, positive 1010 and negative 1012 mentions of brands 1014 may be tracked, such as by comparison of those brands with predetermined sets and/or subsets of “good” and “bad” keywords 1025 for association with those sponsoring brands. Thereby, valuation may be assigned to certain keywords, and the value of certain sponsoring brands may be tracked, based on association with those keywords, over time, in certain geographies, in certain markets, in certain contexts, and/or with regard to certain products or services, and the like. Keywords may, of course, be “good” to be associated with, meaning such keywords are indicative of positive associations with the sponsoring brand, or “bad” to be associated with, meaning such keywords are indicative of negative associations with the sponsoring brand, or “neutral.”

In an illustrative scenario, a football player may be mentioned in association with a particular keyword. The keyword association may be assigned a rating in the range of +1 to +10 for a positive keyword associative mention, or in the range of −1 to −10 for a negative keyword association. Further, the associated keyword may be flagged to not be used in connection with the sponsoring brand. However, the keyword may not actually be applicable to the subject for any of a number of reasons. For example, the keyword may be from a reference by an unreliable source, or the reference may turn out to pertain to party that is not the subject. If so, the keyword association may be revoked, for example. Such associations and keyword ratings of mentions may be performed automatically, or may be performed manually, for example, in response to a request from a particular sponsoring brand.

Illustratively, manual searchers may be trained to use consistent ratings for associative mentions. Further, manual searchers may receive retraining such as wherein, for example, searchers consistently rate a particular mention or series of mentions as having a particular normative value. In such a case, such mentions may be re-routed to a new searcher-in-training until the new searcher consistently rates such mentions within a predetermined narrow range of the normative value.

Thereby, a brand or talent may have associated therewith a “heat index,” wherein the greater the total positive rating for all keywords tracked in all markets tracked may constitute how “hot” a sponsor or potential sponsor is globally, or tracked in select markets to obtain a local heat index. Similarly, a total negative rating may be used to track how “cold” a particular sponsor and/or brand is. This heat index may, for example, be activated or invoked by a widget enhancement.

It is understood that the foregoing scenario is exemplary only. Similar tracking may be made to occur not only on a positive or negative association basis, but on other bases as well, such as geographic, product or service type, context, etc. In a further exemplary implementation, the aforementioned “hot” and “cold” rating system may be used to draw a geographic “heat map,” wherein the rating of a sponsoring brand in particular geographic markets may be laid out on a map illustrating the hotness or coldness of the sponsoring brand in a plurality of tracked geographic markets.

By way of example, the enhancement widget may be provided for association with a reference to a particular subject of interest, and such widget may provide, for example, metrics associated with that subject of interest. Such a widget may allow for the provision of certain enhanced media, in the form of secondary content to the primary content related to the subject of interest, as is understood to those skilled in the pertinent arts. The enhanced media may include advertising for association with the primary content, that is, for association with the subject of interest. The widget content may thus be located responsive to query engine 910, may be content obtained from the content vault 920 by recommendation engine 912, and the widget may be formulated via fulfillment engine 914.

In accordance with the recommendation engine 912, a recommended image enhancement widget may provide website providers and publishers with contextually relevant content for items featured in, for example, editorial images. The widget, such as upon discovering an enhanceable image, may use the enhanceable image as a background to deliver the contextually related content without impacting the layout or other content of the base website. Further, the ability to deliver the widget in accordance with the herein described systems and methods may provide a network of, for example, advertising inventory. As such, the image enhancement widget may be recommended by the recommendation engine, and/or may include, or be linked to, content in the vault.

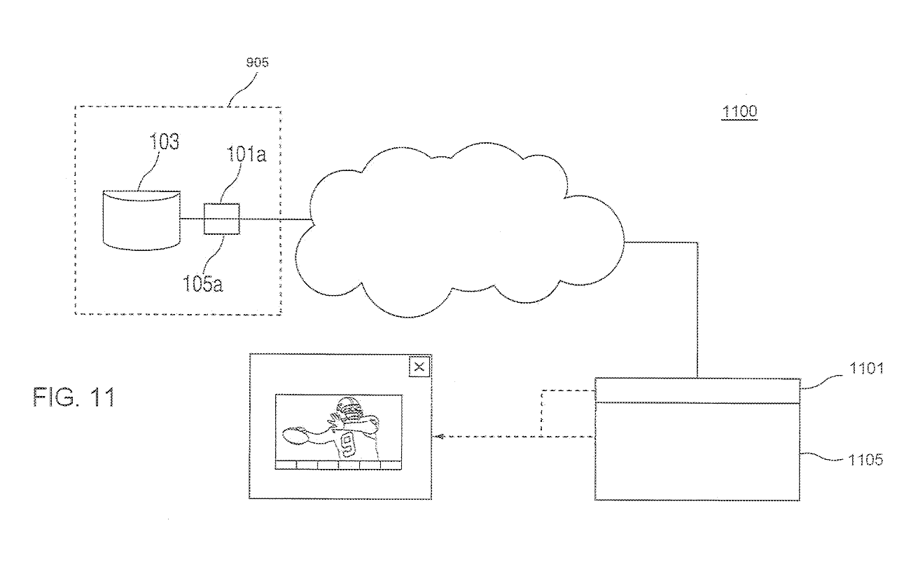

More specifically, and as illustrated in FIG. 11, the image enhancement widget system 1100 may include three principle components. These components are a javascript component 1101, content 1103 from the vault associated with the recommendation engine, such as content obtained by or from a celebrity talent server inclusive of the recommendation engine, for association with and/or relation to a talent, and a flash widget or similar enhancement 1105. Each of the javascript 1101 and content 1103 may be provided by the recommendation engine discussed hereinabove, and most preferably via the talent server within and/or associated with the recommendation engine. The flash enhancement 1105 may preferably be provided by the fulfillment engine, according to instructions and content received from the recommendation engine.

The javascript component 1101 may, for example, be a publisher-side javascript. The publisher side javascript may locate enhanceable images on the publisher's webpage, and provide set up for the flash enhancement 1105 overlaid on the enhanceable image. Provision of the enhancement 1105 may be enabled by placement of, for example, a single line of publisher-side javascript onto the publisher website that the publisher wishes to have enhanced. The publisher-side javascript 1101 may be added to a website by the publisher in, for example, a one-time set up. Following installation, the publisher-side javascript may be further configured remotely, by either the publisher or the enhancement provider, for example.

In an exemplary embodiment, the javascript component 1101 may identify images on a webpage, including enhanceable images, and including images subject to required criteria for enhancement, such as size ranges, aspect ratios, or the like. Upon identification of an image, the javascript 1101 may capture caption text related to the image, alternate text, and/or an image URL, for example, and may send those elements to the talent server and/or recommendation engine, as illustrated. Further, the javascript may display an alert to show a user that a particular image is interactively enhanceable, such as when instructed to display an alert by talent server and/or recommendation engine. Further, the javascript component may enable set up of the flash enhancement 1105, such as by specifying size, location, publisher, talent identification, menu inclusions, and the like, when a user clicks on or mouses over an enhanceable image. Finally, the javascript component may dismiss the flash enhancement based on an appropriate user action.

In a preferred embodiment, the javascript component may not impact an existing page layout. Neither may the flash enhancement, as discussed further hereinbelow, affect the page layout. The javascript component may include an awareness of sight specific design elements, and browser limitations, for example, such that, if unknown elements or unsupported browser aspects are encountered, the javascript component may dis-enable itself. Further, it is preferred that the javascript not appreciably impact load times for the publisher's site. As such, the javascript component may begin activities only after all native website operations have ended for the particular website.

The javascript component may additionally be self updating. As such, the javascript component may change or improve over a period of time. In a preferred embodiment, the website publisher may not be responsible for maintaining the javascript component after installation, but rather the javascript component may check for available downloads of updates at a pre-determined time frame, such as daily, for example, and such as from the recommendation engine, for example. Yet further, the javascript component may preferably be bandwidth neutral with respect to additional traffic over a particular bandwidth.

Thus, the javascript component may be authorized by a particular publisher to enhance any page, or item on a page, that meets certain criteria, such as a size limit, for example, that will allow for enhancement of the item on the page without obscuring the original item or items on the page. If the criteria are met, the javascript component may be installed, and may awaken upon each instantiation of the page, asking for any updates to the javascript component, such as from remote locations, such as the talent server. If no updated versions of the javascript component are available, or after an update is downloaded, the javascript component may assess the images or items on the particular publisher's page, such as by comparison with the criteria, in order to assess which of the images or items may be enhanced. Upon the assessment of which images or items are authorized for enhancement, the javascript component may optionally download the images or items, or certain of the images or items, as a background for the enhancement. The javascript component may then read a text string, such as from an xv header, and may send the information read to a remote location, such as the talent server. The xv header may include, for example, a pix size, an image source, and/or associated textual information, for example. The javascript component may, either prior to sending the information to the talent server, or as information is sent to the talent server, provide to the talent server information related to the reading of the text string, and/or to the assessment of the application of the criteria for the enhancement, for example.

As used herein, the talent server may be or include, individually or in the aggregate, the vault discussed herein and the recommendation engine, wherein the recommendation engine may also serve to authorize enhancements in accordance with certain criteria. The talent server may communicate with the publisher's side javascript component and the flash enhancement widget. When communicating with the publisher's side javascript component, the talent server may manage all communications to and from the javascript component, download images and/or read header files for image or item information, recognize particular talent or entities using header files and all image descriptive texts, indicate to a talent server side javascript the names of talents, certain identifications, such as of image locations, and other required information for the calling of the flash enhancement, download site specific enhancements, and/or provide cache and similar storage, among other functions. The talent server may store, such as in the vault, for example, myriad information that may be made available through the flash enhancement, images and information regarding a variety of talent, and the like, for example.

The flash enhancement widget/addon may be a predetermined or dynamically sized micro site or miniature browser-like application that may use a host image, such as from a base web page, as background in order to provide additional information, preferably related to the celebrity talent or other subject of the host image, for example. In an embodiment, the micro site may be similar in appearance and operation to the addon viewable area described previously in connection with FIGS. 3-6, but is not limited thereto. The flash widget may be configured as an overlay, a cascade out of an image into a fixed size and/or relative position, and may comprise a dropdown menu or series of dropdown menus, and/or an expandable menu or series of expandable menus, or the like. The flash widget provides additional, contextually relevant content regarding the talent featured in an editorial image or item. Through the provision of this contextually relevant content, users may be induced to spend additional time on a particular publisher's page. Further, contextually relevant advertising may be provided in connection with the flash widget.

The micro site nature of the flash widget may enable various and diverse functionality. This functionality may be dynamically sized and/or modified, such as to fit dimensions, aspect ratios, page location, and the like, of a particular image, and/or to fit a predetermined size and/or similar criteria set forth by the publisher. Likewise, in order to avoid interference with the surrounding webpage, the flash component may have opaque, translucent, and/or transparent components, may continue to display the underlying image and/or text, may display the names of the talent discovered in the image, and may have a close, or “X,” button, in order to dismiss or close the flash widget and return to the original view of the underlying image.

In an exemplary embodiment, and in order to fit a dynamic sizing of an editorial image, a widget may be available from the talent server in multiple modes, such as small, medium, and large. Upon loading, the flash widget may select the particular mode, and may self-size to the exact dimensions of the underlying image, or of the expanded image, as desired. By way of example, a small mode may be 300×250 pixels, a medium mode may be 400×300 pixels, and a large mode may be 600×400 pixels, wherein the mode selected is that mode which best approximates the size of the underlying picture.

Further, it may be the case that an editorial image may include more than one talent, or a caption associated with an editorial image may refer to more than one talent. Thus, the flash widget may provide, for example, interactivity, such as a dropdown interface, to allow a user to select what talent to browse in the particular image. Thus, the flash widget may provide a micro site for each subject talent in a particular editorial image including multiple talents. The talent placed at the top of such a dropdown interface may vary based on which talent is being most frequently selected by users with respect to the particular associated editorial image, for example.

The assessment of the subject or subjects of an editorial image may be made, as referenced above, by the javascript component, and may also be made or partially made by the talent server, which may provide or be associated with a server that provides the flash widget. For example, as discussed above, the flash widget may be provided in accordance with information in a header, but, in the event insufficient information is provided in the header, a publisher may provide alt-text, that is, publisher captions, to provide the necessary information. Alternatively, the javascript can estimate on behalf of the flash widget, such as by analyzing the entire page and assuming that which is closest to the editorial image is a caption, and the closest caption presumptively includes information on the editorial image.

The herein disclosed systems and methods may overcome bandwidth limitations apparent in the prior art. For example, it is desirable that the javascript component may do a significant amount of processing, or that the processing may be allotted to the talent server, or that the javascript may be updated on a less frequent basis, for example. Further, by use of the javascript component to read the page header, it is the publisher's site bandwidth, rather than the talent server bandwidth, that will be used in order to assess the enhanceability of all images. Finally, bandwidth may be conserved by allowing the user to select certain processing before it occurs, rather than processing automatically. For example, the micro site flash download may only be provided if a user clicks, for example, a button indicating that the editorial image is interactive. Further, in order to provide additional time for download of the flash enhancement and/or to provide additional revenue, advertising or the like may be downloaded and/or shown to a requesting user as the interactivity is downloaded.

Thus, the present invention may allow for the ready installation of the javascript component, such as on a site HTML template. Related information and/or related articles referencing a selected image, or multiple such methodologies, may be selected, such as the selection of RSS feeds. The settings for an enhancement may be selected, such as the criteria and/or content of such enhancements. Further, a publisher or a user may select the look and feel of a particular flash overlay widget, for example.

For example, a publisher or user may select, as to provide a preferred look and feel of an overlay widget, colors, textures, images, button layouts, sizes, shapes, and the like. Further, certain components may be selected as only conditionally shown to users when certain conditions are met. Further, publishers may select the criteria for production of the enhancement, such as minimum or maximum image sizes available for enhancement, sites, pages, page sections or site sections available for enhancement, use of a floating widget for particularly small images, or the like. Thereby, a publisher may select a look and feel most likely to sustain interest from users or prospective users of that particular publisher's content. Thereby, the publisher's contributions, in conjunction with the herein described systems and methods, are likely to result in an increase of users' exposure to publisher's content.

This exposure may be further enhanced by providing, such as through the flash enhancement widget, links to related stories or images using existing RSS feeds, search and content management capabilities, and the like, which may be provided by the publisher or a third party, and which may be provided from that publisher website, or other websites associated with that publisher, for example. Further, user exposure may be additionally maintained through integration of, for example, third party information, such as third party images, videos, statistics, and the like, including, for example, the metrics discussed hereinabove with respect to FIGS. 9 and 10. As is well known in the art, increased time on a page view may result in increased revenue for the provider of the page, particularly in light of the fact that the present invention may be provided at no cost to the publisher.

Revenue may increase to the publisher not solely in light of increased user engagement and lack of technology investment, development, or provision costs. Publishers may additionally receive value through access to information regarding subject talent of images used on that publisher's website, such as the aforementioned metrics of that talent received from, for example, the talent server, as assessed across multiple websites. Further, the publisher may receive a revenue share on ecommerce transactions related to, for example, advertising provided in conjunction with the flash enhancement. The provider of the flash enhancement may provide this advertising, such as from the talent server, thereby providing an exclusive advertisement position for enhanced images for the provider of the flash enhancement. Further, the provider of the flash enhancement may receive a share of other ecommerce transactions related to the flash enhancement, and may further receive branding and/or links made available through the flash enhancement.

More particularly, the flash enhancement may be ecommerce enabled. For example, shopping support may be provided from third party on-line shopping providers, which third party providers may be relevant to the subject of the editorial image. For example, a sports team online storefront may be provided as shopping support or linked through an advertisement placed in a flash enhancement widget related to a talent in an image that plays for the team the user is a fan of. Likewise, ticket purchasing advertisements, either by teams or third party providers, such as Stub Hub, may be highly targeted to users who have selected to view a flash enhancement related to a subject talent on the teams for which tickets are being offered. Real and virtual sales, memorabilia, clothing, and the like may be provided in association with the flash enhancement advertising. Of course, sponsorships may also be provided in connection with the flash widget, thus providing another opportunity for advertising revenue in association with the herein described systems and methods.

Thus, in an exemplary embodiment, responsive to the javascript component and information assessed by the talent server, the flash enhancement may provide a myriad of information with respect to the subject of an editorial image, such as a professional athlete, in a format selected by the publisher of the site containing the editorial image. For example, a series of clickable menu buttons may be provided via the flash enhancement, wherein each button includes information related to a professional athlete shown in the editorial image on which the flash enhancement is overlayed. Such a clickable menu may provide information on the professional athlete such as biographic information, background information, statistics, team information, such as box scores and standings, and the like. Further, social information may be provided on the athlete, such as the buzz and/or metrics associated with the athlete, recent postings by or about the athlete, real or virtual memorabilia, and/or advertising or media metrics wherefrom an assessment may be made of the desirability of using the subject player as an endorser for advertising, for example.

The information provided in relation to the player may be highly relevant, such as by making use of related articles or feeds from the publisher of the site presenting the enhancement, or from other sites by that publisher, internal or external related articles, relevant blogs or blog postings by the player or fans of the player, or other images of the player, for example. The social engagement in relation to the athlete may allow for access to the athlete's social websites being made available to the public, or chatter about the athlete on social sites, recent blogs or postings about the athlete on social sites, or the addition of the athlete, or a widget associated with the athlete, for example, to a user's social site, for example. Likewise, shopping, sweepstakes, trivia, and fantasy sports support and/or integration may be made available with reference to the particular athlete.

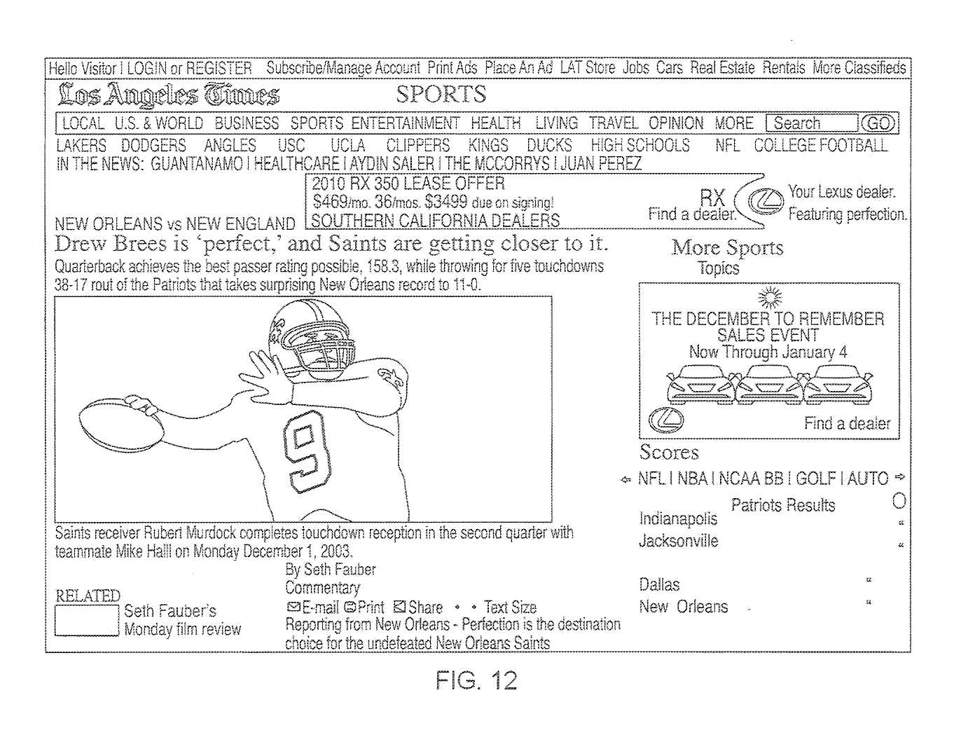

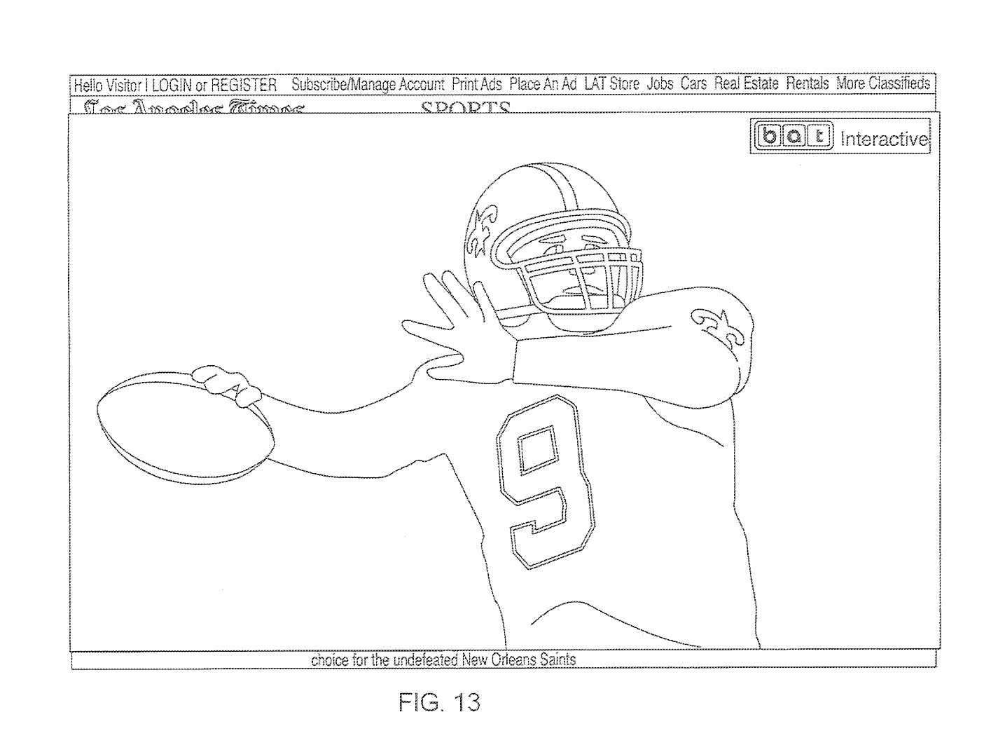

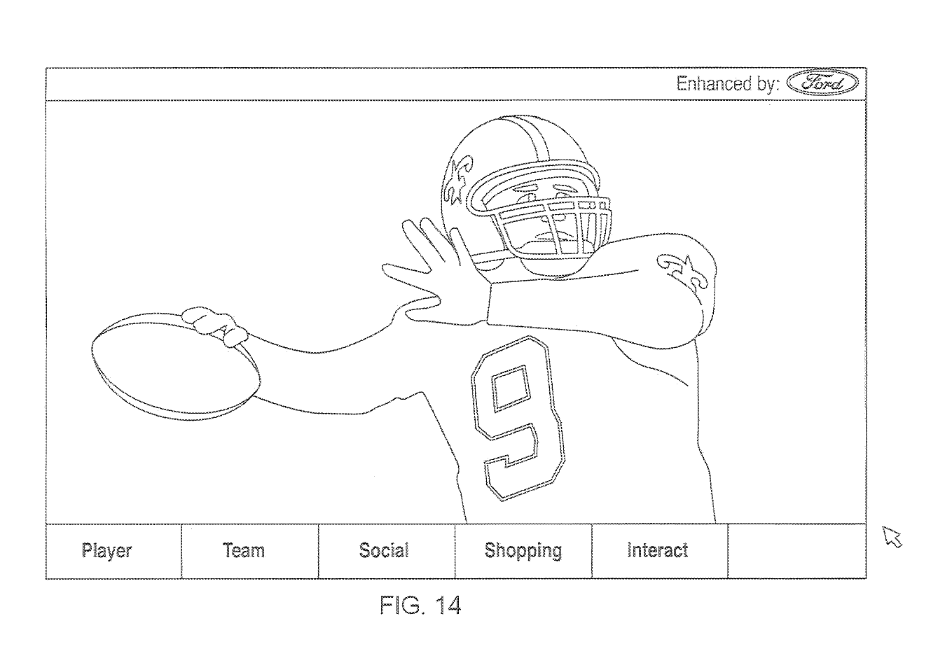

FIGS. 12-21 illustrate an exemplary embodiment of the herein described systems and methods. FIG. 12 illustrates an editorial image provided in a base page of a publisher's website. FIG. 13 illustrates that the subject editorial image may be optionally enlarged, such as upon clicking or mouse over, to enable use of the flash enhancement widget of the present invention. FIG. 14 illustrates a flash enhancement overlay placed atop the subject editorial image selected for enhancement. Of note, the overlay illustrates a top level sponsor for the enhanced overlay. Further, the overlay as illustrated includes information regarding the player, the team of the player, social aspects related to the player, shopping related to the player, and interaction with and about the player. Further provided is a branding and/or link to the provider of the flash enhancement.

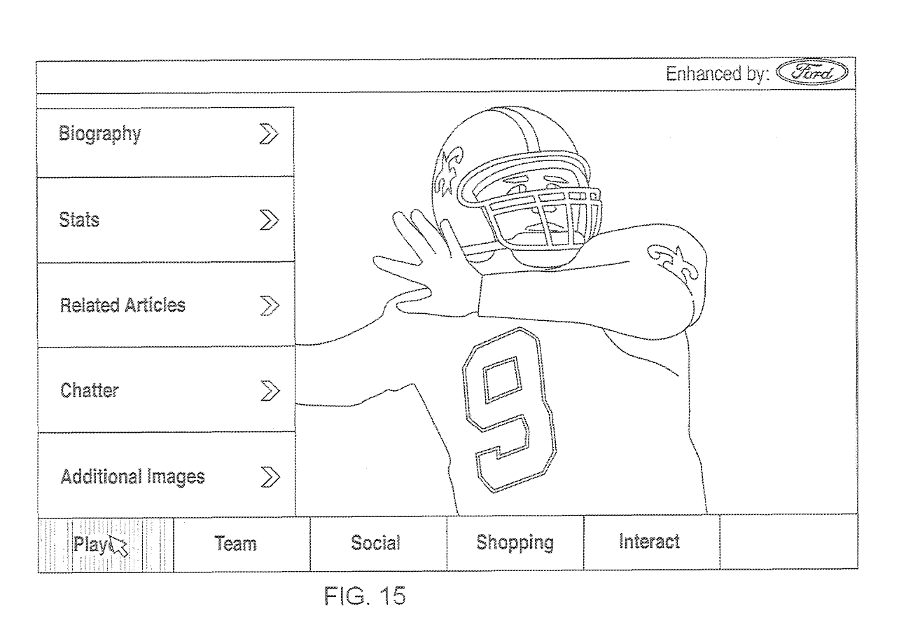

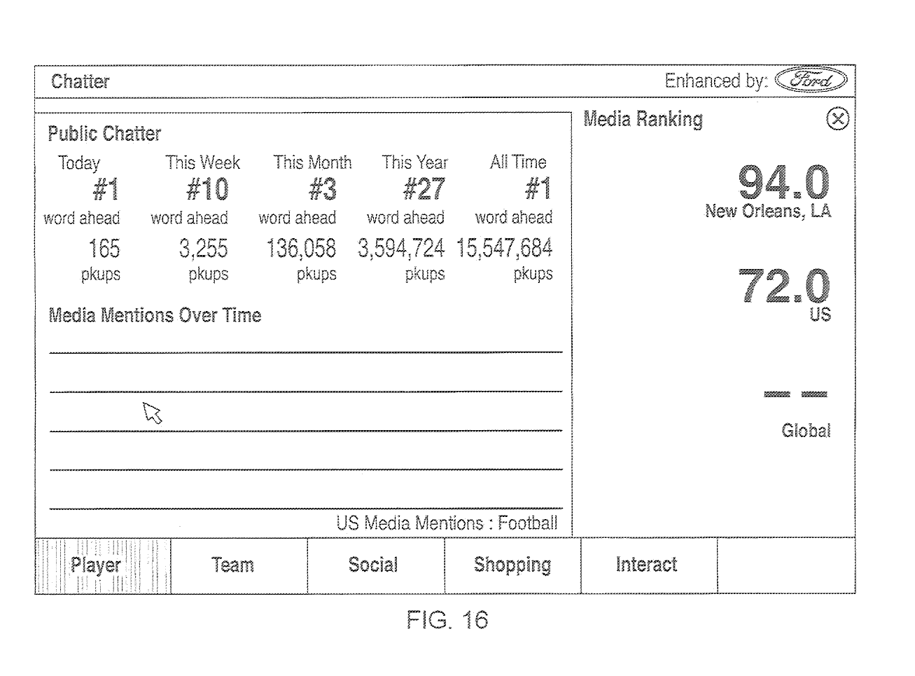

FIG. 15 illustrates a mouse over or similar selection by a user of the player tab of the enhancement overlay. Selection of the tab may allow for presentation of numerous options with regard to the player, such as the biography of the player, statistics of the player, articles related to the player, chatter about the player, and other images, audio, or video related to the player, for example. The statistics of the player may include, for example, game and career statistics for the player, scores or articles about the most recent game in which the player has played, and the like. FIG. 16 illustrates the selection of chatter about the player. As illustrated, chatter may monitor mentions of the user on certain predetermined websites, or across many websites, and may additionally monitor whether such mentions are positive or negative, i.e. may metricize such mentions as discussed hereinabove with respect to FIGS. 9 and 10.

Illustratively, the player illustrated in FIG. 15 plays for a team in New Orleans, La., and thus, it would not be surprising that the media rating, and/or metrics, of the player would be higher in New Orleans than in the rest of the United States. This is illustrated in FIG. 16. Further, the metrics may track chatter about a subject talent over time, as illustrated. The metrics provided may vary based on the flash enhancement selected to be provided. For example, a small sized flash overlay may provide simply a local and national on-line ranking for a selected talent. However, a medium overlay may additionally include a graph of a national and local ranking of the talent for a particular time period, such as over the proceeding three months. Finally, for large sized overlays, mouse over effects may be provided, such as showing specific ratings at given points on a ratings graph.

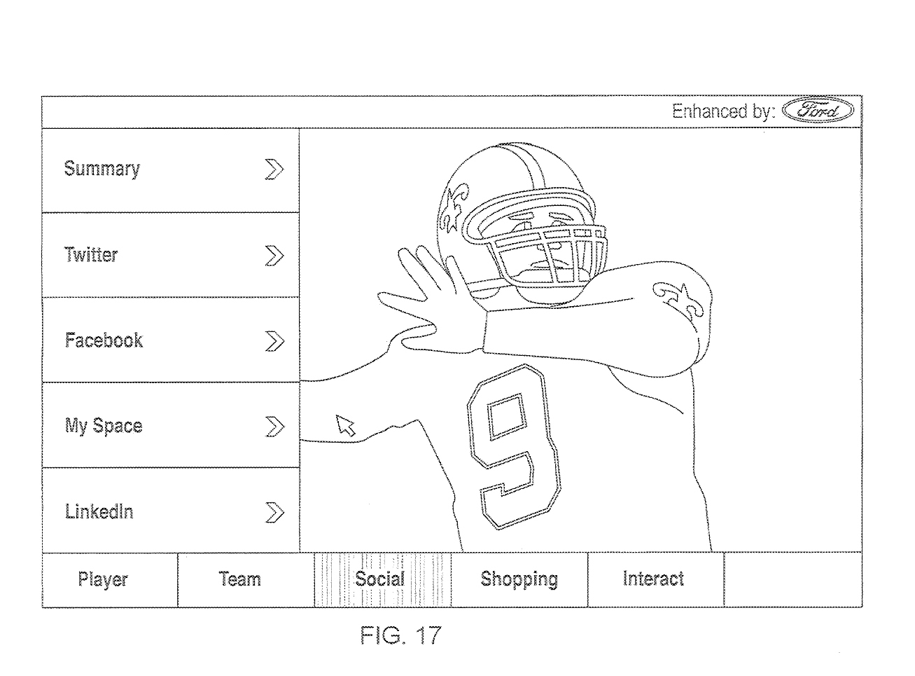

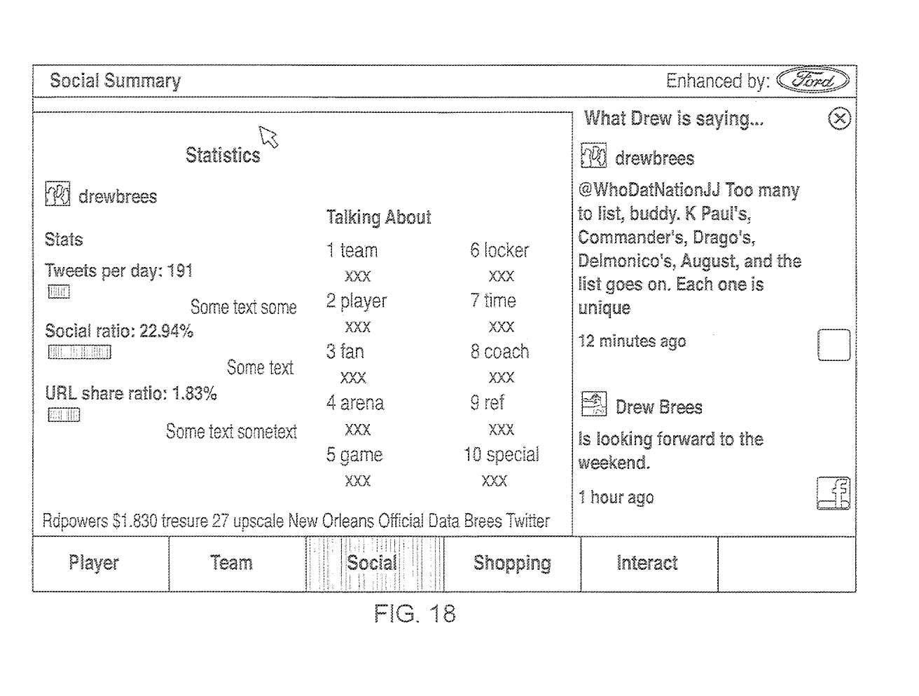

FIG. 17 illustrates a selection, or mouse over, of a social tab in the flash enhancement. Selection of the social tab may provide, for example, a series of aspects related to socializations of the player. For example, social network sites provided by or for the player may be accessible, as may be mentions associated with particular social networks about the player. Further, for example, recent posts on a social site about a talent featured in the editorial image may be provided, such as an association with a logo or link regarding the subject social network site. Additionally and alternatively, a summary of that talent on a social network site, such as a profile icon and/or summary of a profile of the subject talent, may be provided from the social network site. FIG. 18 illustrates an exemplary social summary with regard to the subject of the editorial image. As illustrated, social interactions of the talent may be tracked, and additionally statistics regarding mentions of the talent and the like may be provided.

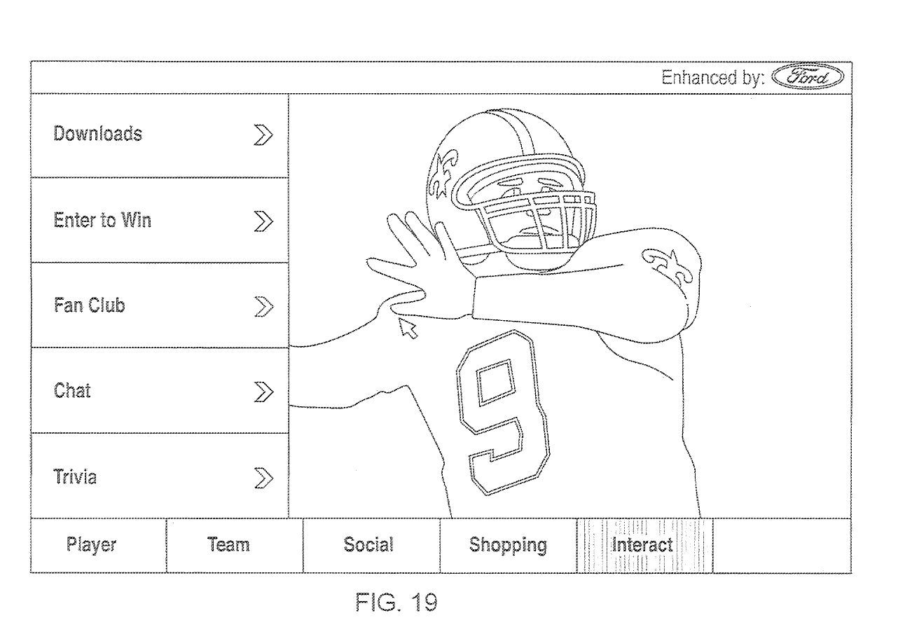

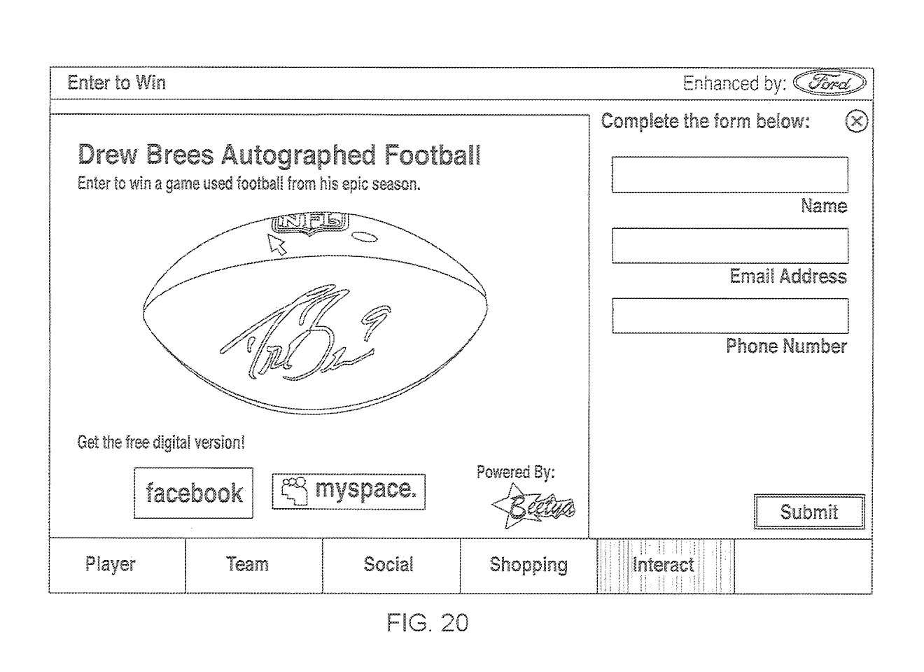

FIG. 19 illustrates a selection and/or mouse over by a user of the interaction tab of the flash enhancement. The interaction tab may provide a plurality of interactions related to the subject talent of the editorial image, such as downloads related to the talent, sweepstakes related to the talent, fan clubs of the talent, chat with or about the talent, trivia related to the talent or an entity associated with the talent, or the like. For example, as illustrated in FIG. 20, a user may elect to enter a contest or sweepstakes associated with the subject talent. Further, as illustrated in FIG. 20 and as referenced hereinabove with each aspect of the flash enhancement overlay, portions of the flash enhancement provided may be transparent or translucent, such as to allow continuous presence as background of the original editorial image.

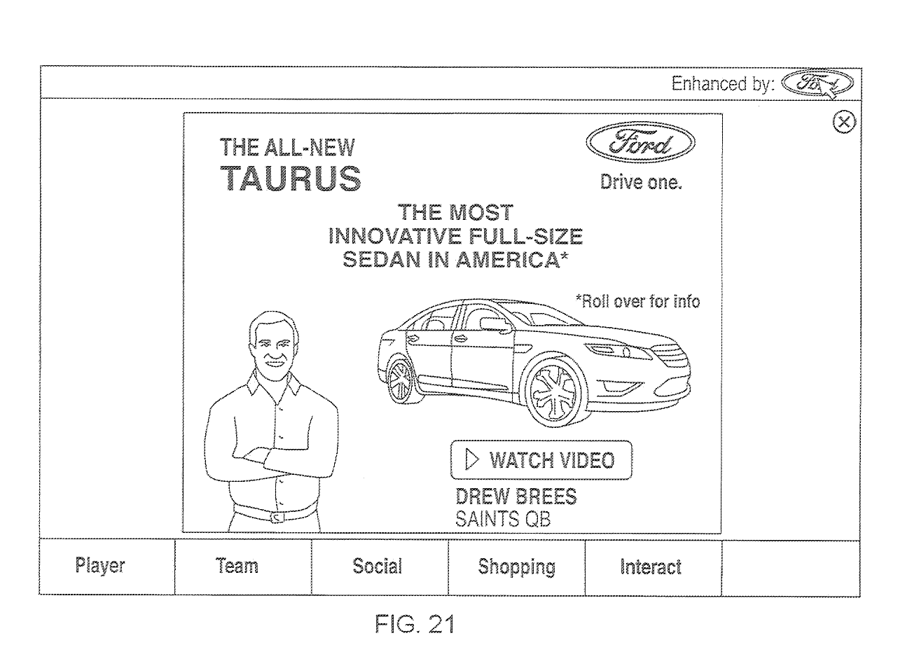

As illustrated in FIG. 21, a sponsor may be associated with the flash enhancement. The sponsor may be selectable by a user, at which time an advertisement associated with the sponsor, and/or featuring the subject talent of the advertisement, may be provided to the user. Additionally and alternatively, a banner ad may be provided within, or associated with, the flash enhancement widget. In a preferred embodiment and in order to avoid conflicting advertisements, it may be desirable, when an advertisement or banner advertisement is displayed in accordance with the flash enhancement widget, that underlying advertisements and/or images, contrary to that discussed above, may not be visible to the user.

In an exemplary flow of the herein disclosed systems and methods, when a user on a web page places a cursor over a subject of interest in a particular article, the mention may be formatted as an enhanced flash media widget, such as wherein the mouse-over causes execution of widgetized code to provide a widget specifically designed for association with a reference to the subject of interest. Such a widget may provide additional information regarding the subject of interest, advertising endorsed by or otherwise associated with the subject of interest, desirable and/or free content, content from and/or stored in the vault discussed hereinabove, or any combination thereof, for example. Thereby, revenue gained through the provision of the subject widget, such as from click-throughs on advertising provided in association with the widget, may be shared between the provider of the widget and the site provider that allowed placement of the enhanced media, for example.

More specifically, the enhanced media may link to a particular item, and/or may provide access to different optional items, such as by provision of tabs in association with the widget provided correspondent to the mouse over. Advertising and other enhanced content may be provided from inventory in the vault. Thereby, revenue sharing between one or more of the advertising entity, the subject of interest, and the site provider may be made available through the use of the present invention.

In an embodiment, the enhancement widget may be presented as a discrete window provided to the user and may take the form of an overlay, a free-standing window, and/or a window within an active window, for example. The widget may take the form of a sidebar which may exist within an active window being utilized by the user to surf content on the internet. The sidebar may offer a specific subset of information to the user and may be tailored and/or customized pursuant to user characteristics and/or the content within the main window utilized by the user. For example, such specific content may include information regarding celebrities.

Celebrities, as used herein, may be people, objects, and/or events which are known to more than one person. In regards to a social network, a celebrity may be any person or persons with a social network following of at least 10,000 people, for example. Outside a definable electronic following, a celebrity may a person who is known for at least one particular reason by a high number of people. For example, a person known by 20% of adults in the United States may have “national” celebrity, while the quarterback for a local high school team, known by at least a majority of those attending the high school might be a “local” celebrity.

A celebrity may also be defined by their “Brand Affinity” rating, a rating which may be calculated in accordance with U.S. patent application Ser. No. 12/322,940, entitled System And Method Of Assessing Qualitative And Quantitative Use Of A Brand, filed Feb. 9, 2009, the disclosure of which is incorporated by reference herein as if set forth in its entirety. Further still, celebrities may be identified and/or sorted by the number of followers the person and/or object has in various social networks. For example, a person may have a Twitter® following of over 100,000 followers and may qualify thereby as a “celebrity” in relation to the total followers of other Twitter users.

The sidebar may be made visually active by the user and may provide thumbnail information related to the specific information being provided. For example, celebrity information may include a thumbnail picture of the celebrity, the celebrity's name, the celebrity's rating and the celebrity's current occupation, such as, actor, athlete, chef and/or writer, for example. The thumbnails may be arranged in a vertical format within the sidebar and may be accessed by scrolling down within the sidebar utilizing the included scroll bar functionality associated with the sidebar. As will be appreciated by those skilled on the art, the views provided by the sidebar may be varied pursuant to the user's tastes and may not include, for example, images within the thumbnails to conserve bandwidth and/or processing speed of the device on which the sidebar is being utilized.

Although the enhancement aspects of the present invention may run against one or more active windows without at least visual activation by the user, the sidebar may be presented and/or activated by the user on one or more of the user's active windows. Such functionality may be controlled by the user and may allow the user to visually access the sidebar only when activated within each discrete window, or may allow the user to choose to allow the sidebar to be active in each and every window the user activates. The user may also allow the sidebar to be active only within certain windows which may deal with, for example, information related to the information within the sidebar. By way of example, a sidebar providing information on celebrities may be limited by the user to be active only against URLs and/or actual delivered content related to celebrity information. Thus, active windows pertaining to strictly business functionality may not be availed access to the sidebar, and/or may be disabled.

The sidebar may include a search function wherein a user may enter a celebrity's name and/or occupation, for example, and be returned a list of results to select from. Such results may, for example, be optimized and/or filtered versus the user's attributes, the popularity of certain celebrities to other third party users of the sidebar, and/or the ratings previously described. The sidebar may also include options to view featured content (such as that content chosen by a third party sidebar administrator), for the user to review recent celebrity selections, for the user to view what may be considered “hot” by other users of the sidebar, and/or for the user to perform a search or simply list celebrities denoted by the user as her favorite celebrities. These favorite celebrities may be celebrities for which the user wishes to track by deliberately selecting them for inclusion within the normalized view of the sidebar, and/or may be celebrities chosen by the present invention to be included in the user's normalized sidebar view when taking into account user attributes.

In addition to being provided a separate tab showing what celebrities may be most actively viewed by other users of the sidebar, simply mousing over the thumbnails of the provided celebrities may provide information related to third party viewing of that celebrity. Such information may include, for example, the number of third party users who have not celebrity included within their sidebar and/or the number of users who have searched and/or viewed information related to that celebrity. Similarly, mousing over a celebrity thumbnail may provide the user with third party information related to that celebrity such as, for example, articles, news, and/or social website activity either about or interacted with by the celebrity. Such information may also be included in a separately generated window if the user, for example, selects a particular celebrity from within the sidebar.

A display area or secondary window generated by the user's selection of a particular celebrity may provide the user with information of and even access to the particular celebrity. For example, more information may be provided in the immediately executed window that may form a part of the sidebar. The information provided may take the form of an additional image, for example, and may further include drop down menus and/or access to various applications and/or widgets.

For example, access to various applications, social networks, RSS feeds, and the like may be focused on the celebrity presented within the sidebar window. If information related to the selected celebrity exists through one of the aforementioned platforms, such information may be revealed at least in part by the user mousing over the platform's icon. By way of further example, mousing over an icon representing access to You Tube® may provide at least an indication of, and/or information related to, content available through You Tube related to a celebrity, such as Jessica Simpson. If a user selects one of the platforms provided by the secondary sidebar window, that information may be provided within and contained by the secondary window. Thus, a user choosing the You Tube icon may be presented with videos within the You Tube interface that are relevant to Jessica Simpson. These videos may be played and/or reviewed from within the secondary window, and thus not disturbing to and/or interacting with the content delivered to the user within the main window.

Similarly, a selected platform's functionalities may be condensed and presented within the secondary window. Such functionalities may be invoked by a user clicking an icon presented in the secondary window. For example, a Hollywood Reporter® magazine icon may be selected by the user, to obtain within the secondary window dedicated information culled from the Hollywood Reporter® magazine website regarding the celebrity Jessica Simpson. Although the herein disclosed systems and methods may return celebrity specific information in a hierarchical manner, such information, or at least recent information, may or may not be provided or made available at each platform provided through the secondary window of the sidebar.

In an exemplary implementation the selected platform of the Hollywood Reporter may provide to the user, within the secondary window, tabs delineating top stories, film topics, television topics and music topics. If the content and/or information provided by the Hollywood Reporter within its top stories tab does not pertain at least indirectly to Jessica Simpson, the results presented to user within the Jessica Simpson-denoted or -directed secondary window may simply include those articles typically provided by the Hollywood Reporter, within its top stories tab, to viewers of content directly through the Hollywood Reporter's main website. Thus, any platform may be offered within the sidebar and/or the sidebar secondary window, regardless of the relevance that the accessed application may have to the celebrity that may be associated with the user.

As previously disclosed, the content launched by the user through the secondary window may be limited to functionality within the secondary window, although the present invention may also allow for the launching of a new window in which the selected content may be viewed by the user. Launching content in a new window may allow the user to interact with such content as if the content was accessed directly without launching through the sidebar. However, the herein disclosed systems and methods may review the site's contents and may provide the user the opportunity to further access enhancements related to the information within the user's sidebar. For example, if the sidebar provides the user with celebrity information, an embodiment may review the content of the website for mentions of celebrities, and may further seek images connected to the mentions of the celebrities, for example. If, for example, images are found and are determined to be related to at least celebrity mentions, the present invention may tag the images with a small overlay icon denoting that enhancement by the sidebar is available to the user within that web page. As will be discussed in more detail below, such sidebar enhancement may provide the user the ability to add information to the sidebar and/or may provide the user with greater information regarding the at least one identified celebrity.

A search performed within the sidebar may provide a list of celebrities. For example, a search of the name “Lee” may result in a listing of celebrities, and/or brands, having a first or last name of Lee and/or the letters L-E-E within their name. A selected result may launch the sidebar secondary window, thus providing more information regarding the celebrity, and may provide the user the ability to add the selected celebrity to her sidebar list of celebrities for whom she desires to track information. The secondary window may be separated from the sidebar and may be provided with a drop down menu that may allow access to various features provided through the present invention. Such features may include access to an application warehouse, may allow the user to share via Facebook and/or other social networks, may allow the user to share via email and other forms of electronic communications, and/or may provide access to publishers, advertisers and/or developers of applications to, for example, the system 905.

The sidebar may also provide a user with instant access to information related to sidebar content, such as social network postings. For example, selecting the celebrity Katy Perry may provide the user with the most recent posting(s) by Katy Perry to a social network. Thus, the herein disclosed systems and methods may provide a clearinghouse aspect allowing a user to receive any number of social network postings made by a user-defined subset of celebrities. This clearinghouse aspect also applies to any and all content available through the worldwide web related to the user-defined or -specified celebrities. Furthermore, access may be provided to applications, such as, for example, system metrics related to each celebrity, via an application icon located either in the sidebar or the secondary window.

The herein described systems and methods may allow for the enhancement of content located on third party web sites, and may provide an indication to the sidebar user that such content is available. A small insignia, watermark or like mark may be provided on identified content that may be enhanced within a base web page. The identified content may be selected by the user and may provide an enhancement. Thus, a secondary window, as described above, may be provided to the user within a primary content window such as a base web page otherwise uncontrolled by the sidebar. In this way, without at least visual activation of the sidebar, content interacted with by the user may still be enhanced as described herein.

In an embodiment, an addon application may periodically or at random intervals launch selected or random other addon applications. The addon may launch another addon application for a limited time, such as ten seconds, then switch to another addon application, etc. In this way, a collection of addon applications may be automatically launched, for example, to determine which applications a particular user, set of users, or users in general, are disposed to interact with.

Alternatively or in addition to invoking herein disclosed systems and methods by a user, a publisher or operator may invoke one or more systems or methods. For example, a particular website or web page may cause a user browser's sidebar to launch. This provides a way for publishers to offer enhanced content even if they have no celebrities or the like identified on their web pages.

In an illustrative operation, a browser addon application may detect when topics of interest are or have been addressed by a celebrity, such as in a tweet or other broadcast. For example, an addon may recognize that a celebrity recently sent a tweet about her jewelry, and highlight references to jewelry (e.g., including references to rings, earrings, bracelets, etc.) on a base web page. When the user mouses over of selects a highlighted term, the addon will show the relevant tweet.

In an illustrative operation advertisements and the like can be served to a widget installed locally on a user's computer terminal. The advertisements can be presented in a variety of ways. For example, ads can include text, images and graphics, animation, video, audio, or any combination thereof; they can be opaque or semitransparent in any degree. They can be customized for viewing by a select group of users, such as based on geographic location; or even by a particular user, for example, by tracking user-identified talent, subjects, or other topics of interest and selecting advertising creatives that relate to those favorites; or by analyzing the viewer's interaction with various browser widgets, preferably with the user's permission or opt-in. Ads can be displayed within a widget frame, such as in a widget viewable area or a sidebar. Alternatively, ads can be displayed outside of a widget frame, for example, floating across the user's screen, or interacting with select identified screen elements, in any desired manner.

Moreover, various parameters pertaining to advertising may be tracked, such as the time of day an ad is presented, and/or the duration that an ad is presented, the number of computer terminal users for whom the ad is displayed, the talent or subject matter of the ad, the brand being endorsed, and the like. Various revenue models may be implemented in accordance with or based on the measured parameters.

The herein described systems, methods, addons, and the like may be provided by a single distributor, or may be customized for use by different distributors, and/or with different celebrities/talent, and/or for use in different contexts, such as a lone browsing context, a shared social browsing context, an educational context, a commercial transaction facilitating context, etc. Addons may be distributed that pertain to particular celebrities that include customized content pertaining to that celebrity, such as favored charities and causes, etc. Modifications may be made available for use by users to adapt otherwise generic or default-configured addons to have particular preferred elements and/or associated with preferred content.

Addons can be activated in accordance with enhancements made by a web page's publisher or operator. Thereby, the widget and other addon operation can be directed to only publisher-approved pages. For example, the website of a newspaper may choose to enhance only the sports and entertainment sections of its website, while not enhancing the local, national, and international news, weather, and fashion sections.

A user, publisher, website operator, celebrity, or the like may modify enhancement attributes such as the appearance, and/or operation of select elements of an enhanced browser interface. Such attribute modifications may collectively alter the look and feel of a widget or other enhancement. Such collections of modified attributes are referred to herein as “skins.” For example, a publisher may remotely control the appearance and/or operation of select widgets when a user visits an enhanced page, thereby implementing a publisher-defined skin. Similarly, a skin may be applied to a widget in accordance with the subject that has the widgets focus, such as a celebrity. Thereby, the celebrity may implement a celebrity-defined skin when the user is browsing an enhanced web page and focuses an enhancement on the celebrity.

Select enhancement elements may be implemented such that they respond to mouse events, such as mousing over the element. For example, mousing over a celebrity block in a sidebar may cause that block to be enlarged and present additional information of the subject of the block, such as most recent or most popular articles regarding a subject celebrity culled from entertainment news sources or the like. The sidebar may provide a field a user can type a celebrity subject's name in to search one or more remote databases for news, events, images, statistics, and customized addons pertaining to that celebrity.

The remote databases searched may include databases maintained by operators of social networks such as Facebook or the like. In an exemplary operation, a user may mine Facebook for their celebrities based, for example, on a number of “friends” or the like, and may update or synchronize a locally or remotely stored list of celebrities with the results. In an implementation, celebrities' applications may be downloaded to a local terminal as part of such an operation.

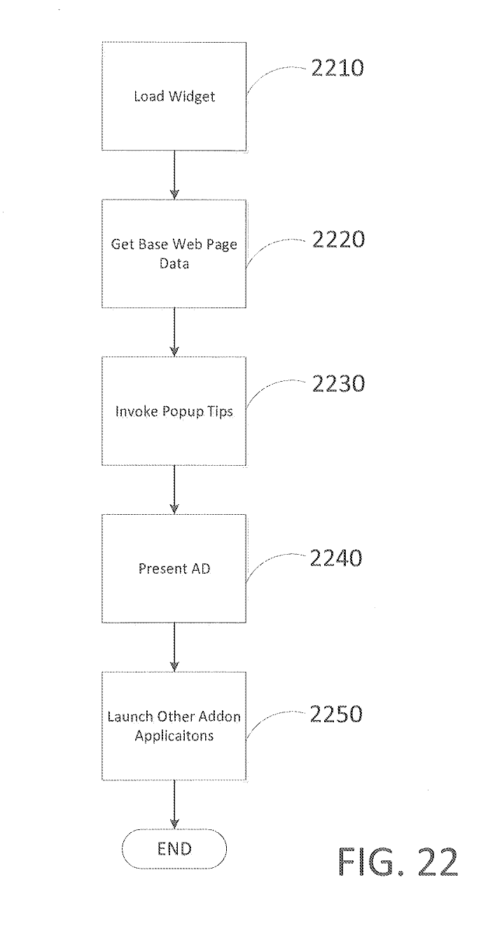

As shown in FIG. 22, a more detailed exemplary method of enhancing a base web page, as compared to the illustration of FIG. 3A, may include loading a widget, 2210; getting data of the base web page, 2220; invoking pop-up tips, 2230; presenting advertising 2240; and automatically launching other addon applications, 2250. In an exemplary implementation in accordance with the herein disclosed systems and methods, a celebrity may record information regarding topics of interest to the celebrity, such as sound or video clips, quotations, or the like. The celebrity may be included in a database of a provider of web browser enhancements. When a base web page is analyzed and the celebrity is recognized as appearing in the text and/or images of the base page, one or more of the recordings may be displayed when the celebrity becomes the focus of user activity, such as by clicking on an enhancement to obtain information of the celebrity. Such recordings may pertain to recent newsworthy events about which the celebrity desires to publish a message. Such events may or may not involve the celebrity directly. For example, the celebrity may desire to respond to winning an award, or to revelations or allegations about recent behavior, or the like. Or, the celebrity may desire to publish content in relation to an ongoing disaster or the like, such as to solicit donations. In an exemplary implementation, a celebrity can address a user in connection with any editorial content on the web that relates to the celebrity, when the user encounters and focuses the addon on the celebrity.

An addon may provide a browser user with a visual cue that a favored celebrity is currently online. When the cue appears, the user can invoke an add-on application that allows the user to participate in a social browsing experience. Such a social browsing experience can include, for example, a broadcast initiated by the celebrity and received by the user and other users similarly disposed. For example, the celebrity may schedule a broadcast at a predetermined time to maximize viewership of the broadcast. The celebrity may then broadcast an audio or video program to users, either live or pre-recorded, such as using a web-enabled video camera and/or microphone.

The herein described systems and methods can consolidate the foregoing content for access by a user. The content may relate to any of a list of celebrities selected by the user and stored at the local terminal or on a remote server. In addition, addon applications can be adapted to access information hosted on a website that requires user registration when accessed directly by a user, but not when accessed within an addon application. For example, if enabled by Twitter, a user need not have a Twitter account or register with Twitter in order to read the celebrity's tweets.

In an exemplary implementation, a “Capitol Hill” browser enhancement can comprise or invoke one or more addon applications to focus on politics, to give a user relevant political information and put the user in touch with his representatives. Information of the representatives may be stored in a remote database for access by addon applications responsive to user events. Such information can pertain, for example, to federal representatives such as the president, senators and congressmen, and/or state representatives such as the governor and state senators and other representatives, as well as government representatives at a local level such as county and city representatives including mayors, freeholders, and the like. Such information may be provided by local reporters, or may be gleaned from known sources of information publicly available via the internet. Information can be updated automatically or manually, and may include legislative histories, voting records, bills, recordings and/or transcripts of speeches given on the floor of Congress, and the like. An enhancement may invoke an email application and automatically fill in fields of information needed to send the email such as the recipient representative's contact information, subject line information, a shell message formatted appropriately, and the like, generated in connection with a particular bill or topic the user us focusing the browser on. The user's representatives may be identified manually by the user, such as by selecting from drop-down lists, or may be determined automatically by the addon, such as based on the geography reflected in the user's Internet Protocol (IP) address. If an Application Programming Interface (API) is provided in connection with a web-based application, the enhancement may use the API to interact with the application. For example, if Twitter provides an API to access its information, that API can be used by an enhanced web browser to gain access to information on Twitter's servers. If Congress provides an API in connection with stored information pertaining to congressional activities, that API can be used by an enhanced web browser to gain access to the congressional information.

In analyzing the contents of a base web page, the herein disclosed systems and methods may analyze text and metadata of the web page and its contents, and/or may automatically recognize subjects of photographs and the like. A web page publisher's rules and guidelines for web page presentation, if any, may be followed when the page is enhanced. Further, different versions of enhancements may be provided, such as by providing different scripts or the like, based for example on the web domain, type of user browser, user IP address, etc. In this way, base web page enhancements may be modified to account for the source of the page, the recipient and viewer of the page, or both.

In an exemplary implementation an addon may have very limited capabilities, e.g., if a user clicks this element, then retrieve that information from a remote server. For example, upon a first use, the addon may perform a first operation, and thereafter may be redirected. An addon may detect subject content, the content publisher, the browser type, the local terminal IP address, etc., and its appearance and/or operation adapted accordingly. Thereby, a user's browsing experience may be adapted to target that particular user.

Addon applications in accordance with the herein described systems and methods may be installed on a plurality of a particular user's computing terminals. For example, a user may have a PC, a tablet computer, and a smart phone, each with its own web browser, and addons may be installed on each device. In that event, information specific to the user on one device may be made accessible to, propagated to, and/or be synchronized with one or both of the other devices, using methods known in the pertinent arts.

In an exemplary implementation, an online broadcaster, such as a teacher for example, may broadcast a web session, such as an educational session, that may be accessed by any and all users, or may broadcast only to designated users such as registered members of a class. Such a session may include a broadcasted web browsing session, combined with audio and/or video, such as a teacher commenting or lecturing on the web browsing. Users such as students may view the browsing session. There may be more than one broadcaster, for example, a plurality of presenters in a panel discussion to a user audience. Users may be granted the ability to broadcast as well, for example, to ask the panel questions, so that only a select one or more panel members, or all panel members, or the panel plus all users, or just the user community but not the panel, may see and/or hear the broadcasting user.

Those skilled in the art will appreciate, in light of the disclosure herein, that the claimed invention is thus highly useful to all parties in the aforementioned widget transaction. For example, the advertiser can obtain new advertising inventory by placement of the enhanced media. By way of further example, the site provider may incur additional rich media that may be placed on the site without cost to the site provider, and that, in fact, may provide additional revenue to the site provider. Such rich media, due to the use of a widget in the present invention, may include the widgetization of desirable content, such as the flipping of Getty images like trading cards, with statistical information on the back of trading card, for example. Finally, the present invention proves useful to the subject of interest in the enhanced media, particularly in embodiments wherein an advertisement for which the subject of interest is an endorser is provided. From the provision of the endorsed advertisement, the subject of interest generates revenue when a user acts on the advertisement.

In order to encourage viral propagation of the herein disclosed systems and methods among users, current users and participating celebrities may publish to their Facebook pages, tweets, and/or other web-based resources “teaser” content that references further “enhanced” online content that requires the installation of one or more of the hereindescribed addons to be fully enabled, along with a link to download the required addons. Alternatively, the link may be to the enhanced content itself, and the required addons may be downloaded and installed automatically to a user's computing terminal when the user clicks on the link to the enhanced content. The teaser content may be generated by a teaser publisher using a separate or reduced-capability “light” addon. The light addon inserts into the publisher-generated messages or other content the link needed by the message recipient to download one or more addons that provide the functionality described in the foregoing.

Correspondingly, the celebrity may have signature enhancements or s suite of enhancements associated with that celebrity. The user may, in fact, have access, such as via the afore-discussed sidebar, to signature features associated with celebrities who that user has “friended” on Facebook, for example. Likewise, a particular celebrity may be spotlighted by particular apps, particular enhancements, in association with particular advertisers, or the like. As such, the present invention may provide, in essence, a micro-site for a particular celebrity in the form of apps, content and/or ads uniquely associated with the celebrity.

Although the invention in its various aspects has been described and illustrated in a variety of exemplary forms with a certain degree of particularity, the herein described exemplary forms have been made by way of example and not by way of limitation. Those of skill in the relevant arts will recognize in view of the instant disclosure that numerous changes in the details of construction and combination and arrangement of parts and steps may be made without departing from the spirit and scope of the invention, which is defined in the claims. Thus, it is intended that the present invention cover modifications and variations of the herein disclosed systems and methods provided they come within the scope of the appended claims and their equivalents.

What is claimed is:

1. A system for providing an enhancement to primary content displayed in a web browser, comprising:
a javascript component that, upon execution, identifies at least one subject of the primary content on a networked page displayed in the web browser, and at least one permission regarding the primary content; and
a widget capable of providing the enhancement, the enhancement comprising at least one application and at least one injected advertisement associated with the identified at least one subject;
wherein a lack of interaction with said widget effectuates a fade out of the enhancement.
